(19) United States
(12) Patent Application Publication
(10) Pub. No.: US 2015/0163626 A1
(43) Pub. Date: Jun. 11, 2015

(54) MONITORING SYSTEM, SERVER, MOBILE DEVICE AND METHOD

(71) Applicant: GeoReach Limited, London (GB)

(72) Inventor: Tim Zimmer, London (GB)

(73) Assignee: GeoReach Limited, London (GB)

(21) Appl. No.: 14/407,406

(22) PCT Filed: Mar. 14, 2013
(86) PCT No.: PCT/GB2013/050635

§ 371 Date: Dec. 11, 2014

(30) Foreign Application Priority Data
Jun. 11, 2012 (GB) 1210260.4
Jun. 20, 2012 (GB) 1210861.9
Jan. 29, 2013 (GB) 1301576.3

(51) Int. Cl. H04W 4/02; H04W 4/22

(52) U.S. Cl. CPC H04W 4/02; H04W 4/22

(57) ABSTRACT

There is provided a monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, the server storing a time series of location data for each device, wherein the server is configured to generate an alert message identifying the first mobile device in response to a time series of location data from the first mobile device satisfying a condition.

### BACKGROUND OF THE INVENTION

1. Field of the Invention

The field of the invention relates to monitoring systems comprising a server and mobile devices, as well as to servers and mobile devices for use in such systems, and to methods and computer program products related to such systems.

2. Technical Background

Security is a major issue for people and organizations around the world. Some people and organizations pose a security threat to other people and organizations. Some people within some organizations may pose a security threat to those organizations. While mobile phone communication means that immediate communication may be possible in the case of a security incident, such as an individual telephoning the authorities to inform them that a terrorist incident has occurred, there remain significant challenges, for example for organizations to coordinate their activities speedily to protect their people in the event of an outbreak of a crisis. At present it can take a long time for an organization to find out where all its people are and whether or not each individual is safe, in the aftermath of an outbreak of a crisis. It can also take a long time for an organization to identify suspicious movements of people associated with the organization.

At present it can take a long time for an organization to identify suspicious movements of people associated with the organization.

At present it can take a long time for an organization to identify when two assets which are intended to be together have become separated.

At present it can take a long time for an organization to find out where all its people are and whether or not each individual is safe, in the aftermath of an outbreak or a termination of a crisis.

At present it can take a long time for an organization to find out if any of the users of their mobile devices are not diligent enough in recharging their mobile device battery.

At present some reports of device locations in a device monitoring system may be lost if too many location reports are received in too short a time interval.

A device monitoring system of an organization may be used ineffectively in the event of a crisis, if the system has been used too little in the past for the organization to be experienced in using the device monitoring system effectively. A device monitoring system of an organization may perform ineffectively or erroneously in the event of a crisis, if the system has been tested too little in the past.

3. Discussion of Related Art

In GB2442151B and in WO2006094335A1 there is disclosed a method and apparatus for monitoring electronic communications by way of determining the dialogue that takes place in an electronic communication. In GB2442151B and in WO2006094335A1 there is disclosed a dictionary for analysis of an electronic communication comprising a store of expressions wherein the store of expressions is arranged according to: at least one section, each section corresponding to one of a plurality of grammatical functions; at least one subject, each subject corresponding to one of a plurality of categories of expressions for facilitating monitoring of an electronic communication. In GB2442151B and in WO2006094335A1 there is disclosed a method and apparatus for monitoring an electronic communication utilising the said dictionary.

### SUMMARY OF THE INVENTION

According to a first aspect of the invention, there is provided a monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, the server storing a time series of location data for each device, wherein the server is configured to generate an alert message identifying the first mobile device in response to a time series of location data from the first mobile device satisfying a condition.

The monitoring system may be one wherein the server is configured to generate a plurality of alert messages, each alert message identifying the first mobile device in response to a time series of location data from the first mobile device satisfying a condition corresponding to a respective alert message.

The monitoring system may be one wherein location data corresponds to a location of the corresponding mobile device.

The monitoring system may be one wherein the first mobile device includes an integral GPS receiver, and location data corresponds to a GPS location of the first mobile device.

The monitoring system may be one wherein the first mobile device activates and deactivates the integral GPS receiver a multiplicity of times according to a predefined time schedule.

The monitoring system may be one wherein the plurality of mobile devices include a plurality of smartphone platforms.

The monitoring system may be one wherein the plurality of mobile devices each includes a touchscreen, each touchscreen displaying an icon or button which is operable to generate an SOS alert at the server in response to a single user touch of the icon or button.

The monitoring system may be one wherein each device includes a microphone and audio is recorded automatically by a device and sent to the server in response to a selection of an SOS alert at the device.

The monitoring system may be one wherein each device includes a camera and photographs are recorded automatically by a device and sent to the server in response to a selection of an SOS alert at the device.

The monitoring system may be one wherein each device includes a camera and video is recorded automatically by a device and sent to the server in response to a selection of an SOS alert at the device.

The monitoring system may be one wherein news is pushed by the server to mobile devices in real time, tailored to their precise location.

The monitoring system may be one wherein each mobile device of the plurality of mobile devices is operable to disable a sending of a GPS location while otherwise operating normally.

The monitoring system may be one wherein the monitoring system further comprises a computer system including a display, wherein the computer system is arranged to display the alert message on the display of the computer system.

The monitoring system may be one wherein the computer system is arranged to display images from a plurality of mobile devices on which an SOS alert has been selected.

The monitoring system may be one wherein the computer system is arranged to display CCTV images from a location of a mobile device which has generated an SOS alert.

The monitoring system may be one wherein the computer system is operable to receive input of a Geofence region.

The monitoring system may be one wherein the computer system is operable to receive input of a Geofence region drawn freehand on a representation of a digital map.

The monitoring system may be one wherein the computer system is operable to receive input of a Geofence region, and to display which mobile devices of the plurality of mobile devices are present in the GeoFence region in response to the received input of the Geofence region.

The monitoring system may be one wherein the computer system is connected to the server via a telecommunications network.

The monitoring system may be one wherein the computer system is connected to the server via a local network and/or via the internet.

The monitoring system may be one wherein the computer system is portable.

The monitoring system may be one wherein the computer system display displays splitscreen, multi-angle, real-time video.

The monitoring system may be one wherein the computer system includes a simulation system.

The monitoring system may be one wherein the condition is the first mobile device entering a Geofence region.

The monitoring system may be one wherein the condition is the first mobile device entering a Geofence region during a predefined time interval.

The monitoring system may be one wherein the condition is the first mobile device leaving a Geofence region.

The monitoring system may be one wherein the condition is the first mobile device leaving a Geofence region during a predefined time interval.

The monitoring system may be one wherein the condition is the first mobile device failing to leave a Geofence region by a predefined time.

The monitoring system may be one wherein a Geofence region is discontinuous in that it comprises a plurality of Geofences.

The monitoring system may be one wherein a GeoFence is defined by a route including a start and a destination, and a predefined width of the route.

The monitoring system may be one wherein the condition is the first mobile device is measured as exceeding a predefined speed.

The monitoring system may be one wherein the plurality of mobile devices includes two devices registered at the server as being paired, and wherein the condition is the separation of the two paired devices by greater than a predefined distance.

The monitoring system may be one wherein the server is arranged to send the alert message to parties on a list accessible to the server.

The monitoring system may be one wherein the monitoring system includes a message gateway connected to the server, the message gateway arranged to queue messages sent by the plurality of mobile devices to the server.

The monitoring system may be one wherein the plurality of mobile devices includes covert devices.

According to a second aspect of the invention, there is provided a server of the monitoring system of any of the above statements.

According to a third aspect of the invention, there is provided a mobile device of any of the statements according to a first aspect of the invention, wherein the mobile device includes a touchscreen, the mobile device programmed such that the touchscreen displays an icon or button which is operable to generate an SOS alert at the server in response to a single user touch of the icon or button.

According to a fourth aspect of the invention, there is provided a method of generating an alert message in a monitoring system for monitoring a plurality of mobile devices registered at a server the system comprising the server and the plurality of mobile devices registered at the server, the plurality of mobile devices including a first mobile device, comprising the steps of:

(i) each mobile device acquiring location data;
(ii) each mobile device sending the acquired location data to the server via a telecommunications network;
(iii) the server storing a time series of location data for each device, and
(iv) the server generating the alert message which identifies the first mobile device in response to a time series of location data from the first mobile device satisfying a condition.

According to a fifth aspect of the invention, there is provided a computer program product embodied on a non-transient medium, the computer program product operable to generate an alert message in a monitoring system for monitoring a plurality of mobile devices registered at a server, the system comprising the server and the plurality of mobile devices registered at the server, the plurality of mobile devices including a first mobile device, the computer program product operable to:

(i) receive at the server location data acquired at each mobile device,
(ii) store at the server a time series of location data for each device,
(iii) generate an alert message identifying the first mobile device in response to a time series of location data from the first mobile device satisfying a condition.

According to a sixth aspect of the invention, there is provided a computer program product embodied on a non-transient medium, the computer program product operable to generate an SOS message in a monitoring system for monitoring a plurality of mobile devices registered at a server, the system comprising the server and the plurality of mobile devices registered at the server, the plurality of mobile devices including a first mobile device including a touchscreen, the computer program product operable to:

(i) acquire location data for the first mobile device
(ii) transmit acquired location data for the first mobile device to the server via a telecommunications network,
(iii) display on the touchscreen an icon or button which is operable to generate an SOS alert at the server in response to a single user touch of the icon or button, and
(iv) transmit an SOS alert to the server in response to a single user touch of the icon or button.

In this disclosure, a “server” should be construed broadly to include examples such as a single server in a single location, a group of servers in a single location, a group of servers over multiple locations, or a virtual server over many locations or in the Cloud, as would be clear to one skilled in the art.

### BRIEF DESCRIPTION OF THE DRAWINGS

The above and other aspects of the invention will now be described, by way of example only, with reference to the following Figures, in which:

FIG. 1 shows examples of smartphones which may be used in a monitoring system.

FIG. 2A shows an example of tracking being displayed on a client portal in a monitoring system.

FIG. 2B shows an enlargement of tracking detail from FIG. 2A.

FIG. 3 shows an example of a touch screen icon on a smartphone which can generate an SOS alert.

FIG. 4 shows an example of news which could impact on the safety of users being pushed to them in real time, tailored to their precise location.

FIG. 5 shows an example of an organization's own intelligence being securely integrated and pushed to its users immediately, specific to their precise location.

FIG. 6 shows an example of a user alerting other users to potential danger.

FIG. 7 shows an example of a privacy setting on a mobile device.

FIG. 8 shows an example of an alarm being activated on a phone, and an alarm being activated and displayed at a CRC in response.

FIG. 9 shows an example of images being displayed at a CRC.

FIG. 10 shows an example of CCTV footage been shown on a client portal.

FIG. 11 shows an example of a screen being displayed at a CRC when an asset enters a safe haven defined by a GeoFence.

FIG. 12 shows an alert being displayed on a client portal when a user enters a country.

FIG. 13 shows an alarm being generated on a client portal when a high value asset deviates from a predefined route.

FIG. 14 shows an example of a GeoFence being defined around a particular area.

FIG. 15 shows an example of hospital and police station search results in a client portal.

FIG. 16 shows an example of a client portal on an iPad.

FIG. 17 shows a client portal interface which includes splitscreen, multi-angle, real-time views.

FIG. 18 shows examples of covert tracking devices.

FIG. 19 shows an example of a world viewer being displayed with a plurality of people in several countries being tracked.

FIG. 20 shows an example of a GeoReach™ WorldViewer application being split into three main areas, Header; Map and Listings.

FIG. 21 shows a schematic diagram of an example of a monitoring system.

FIG. 22 shows an example of a GeoReach™ WorldViewer application before login.

FIG. 23 shows an example of a GeoReach™ WorldViewer application login button.

FIG. 24 shows an example of a GeoReach™ WorldViewer application login dialog.

FIG. 25 shows an example of a GeoReach™ WorldViewer application logout button.

FIG. 26 shows an example of refresh time information.

FIG. 27 shows an example of an aerial map with labels.

FIG. 28 shows an example of an aerial map without labels.

FIG. 29 shows an example of a road map.

FIG. 30 shows an example of a screen zoom control.

FIG. 31 shows an example of part of some screen output containing time zone information.

FIG. 32 shows an example of screen output containing lines of latitude information.

FIG. 33 shows an example of a Select an organisation dropdown list.

FIG. 34 shows an example of a Select a group dropdown list.

FIG. 35 shows an example of an assets listing including a number of columns.

FIG. 36 shows an example of Filtering Assets by Last Signal Date.

FIG. 37 shows an example of trails being displayed.

FIG. 38 shows an example of geo-tagged news stories being displayed.

FIG. 39 shows an example of Filtering News by Map Position.

FIG. 40 shows an example of the results of a search for hotels in Paris, France.

FIG. 41 shows an example of ListingType Enumeration.

FIG. 42 shows an example of geographic coverage in a digital map.

FIG. 43 shows an example of a dialog box to enter the name of a place to find.

FIG. 44 shows an example of results for a searched-for place.

FIG. 45 shows an example of Confidence Enumeration.

FIG. 46 shows an example of Geocode Match Code and Match Method Tables.

FIG. 47 shows an example of output when the country Nigeria is selected.

FIG. 48 shows an example of output when a Users tab is selected.

FIG. 49 shows an example of a method for tracking position on a mobile device.

FIG. 50 shows an example of authorized users of a GeoReach™ web application being able to observe a user's mobile device location.

FIG. 51 shows a schematic overview of an example of a monitoring system.

FIG. 52 shows an example of an alerts page from a Tracking Database.

### DETAILED DESCRIPTION

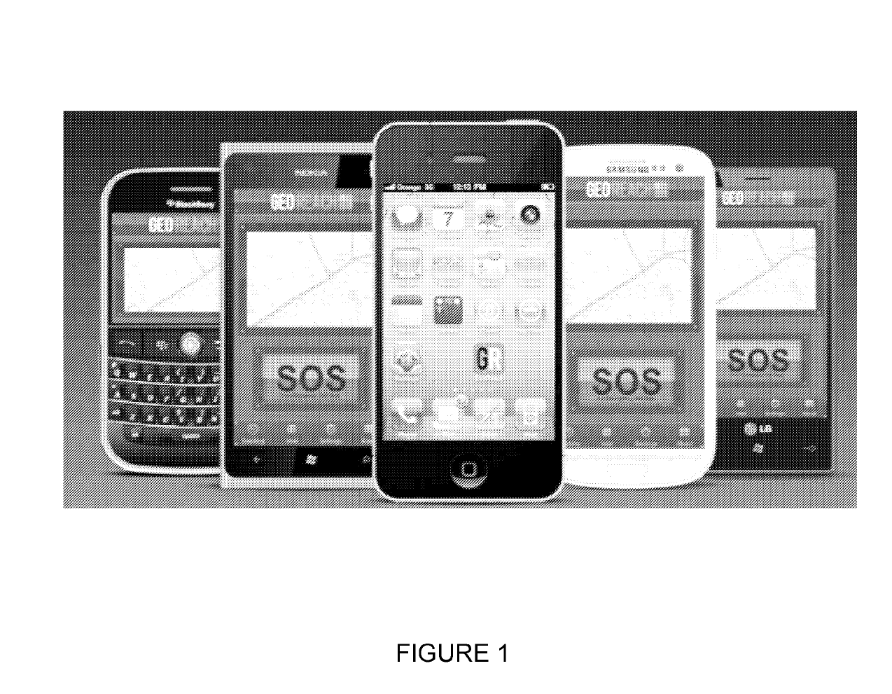

The GeoReach personal and asset safety system can be used with a variety of phones eg. smartphones. Examples are iPhones, Blackberry devices, Windows phones (eg. Nokia) and Android devices (eg. Samsung, LG). See FIG. 1 for example.

Georeach employs next generation technology to keep your people and assets safe. Regardless of the smart-phone, network or country users are in, Georeach works across them all—seamlessly. In an example, part of the system includes an application running on a phone eg. a smartphone.

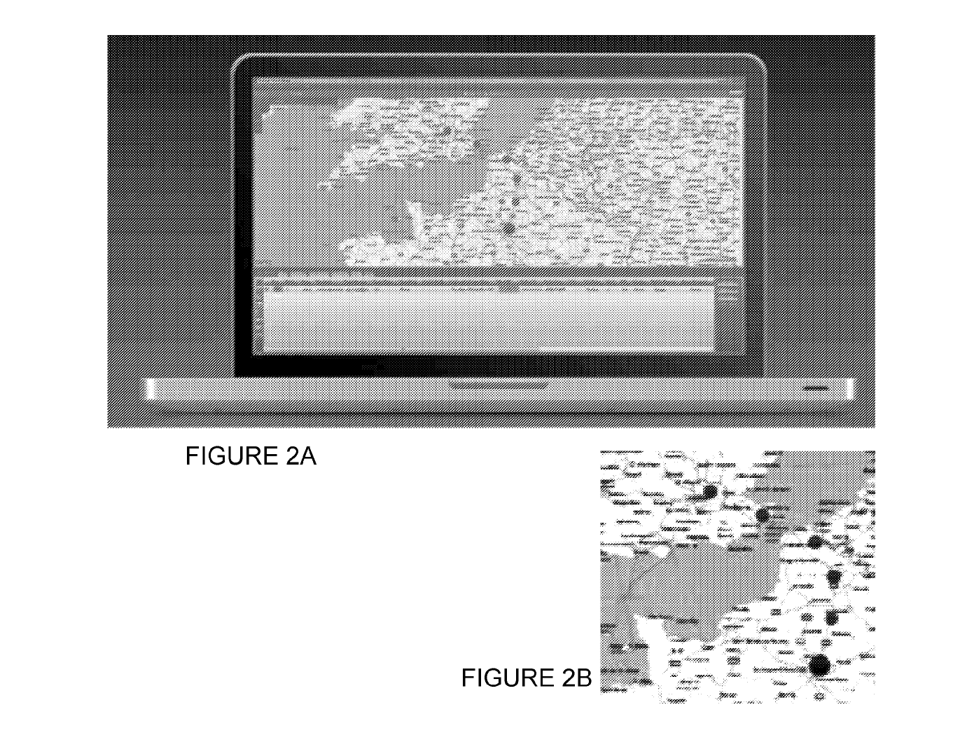

By using global positioning system (GPS) receivers coupled with our unparalleled database of cell tower, satellite and wifi hotspot locations (i.e. their latitudes and longitudes) we can accurately track and locate users to within 38 centimetres. Wifi location databases provided by third parties may also be used. In an example, a person is tracked while travelling from London to Paris. Tracking may be displayed on a client portal: FIG. 2A shows an example. FIG. 2B shows an enlargement of tracking detail from FIG. 2A. In the cell tower database lookup, spurious results may be eliminated. For example, a mobile cell tower is possible eg. at a music festival. The location stored for that cell tower might be from a previous venue, far away. When a cell tower location is inconsistent with other location data, such as with the locations of two other mutually nearby cell towers whose signals have been received, the inconsistent location data is removed from the analysis, or it is highlighted for further analysis. Another possible source of location data is a GeoLocation application programming interface (API) provided within an html5 standard in a web browser location service. Location data sent by a mobile device includes any data suitable for identifying a location, such as GPS-derived position data, cell tower data, cell tower data including timing advance data, or wifi hotspot data, for example.

Georeach technology processes thousands of variables every second—we eliminate GPS spikes and provide more accurate location data than a phone's standard GPS. For example, a GPS spike is one in which a user's position moves too far in too short a time interval to be feasible. This can happen because GPS receivers sometimes provide an incorrect position.

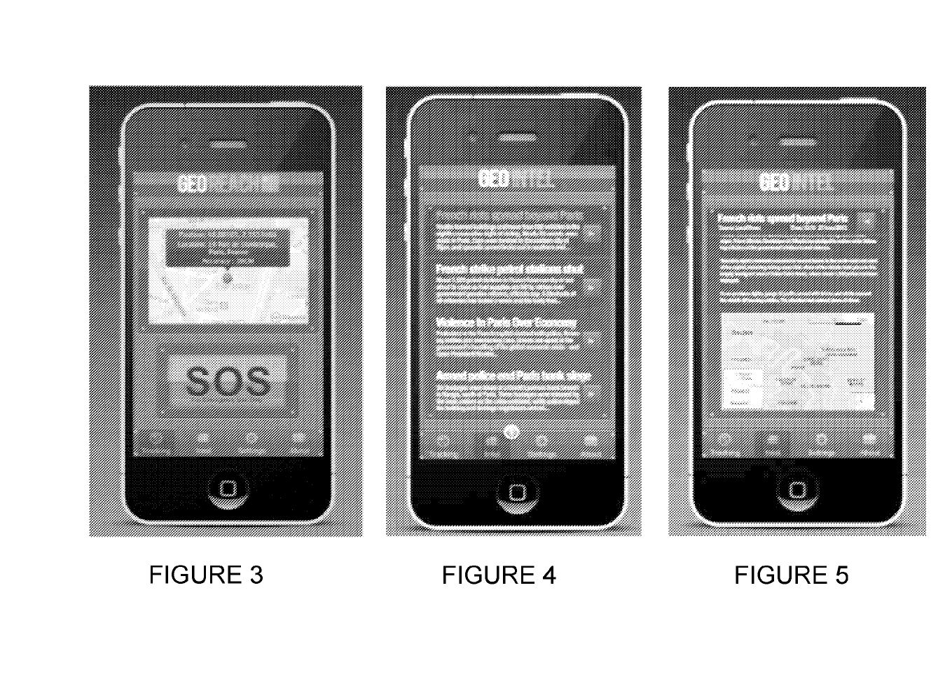

A user's position may be shown on a mobile device, together with a touch screen icon which can generate an SOS alert. An example is shown in FIG. 3. Audio may be recorded automatically by a device and sent to the CRC in response to generation of an SOS alert. Photographs may be recorded automatically by a device and sent to the CRC in response to generation of an SOS alert. Video may be recorded automatically by a mobile device and sent to the CRC in response to generation of an SOS alert. Each mobile device includes a battery and a processor.

GeoReach even works on the rail network (eg. Eurostar) and on wifi-enabled metropolitan underground networks, eg. New York, Hong Kong, London and Paris.

News which could impact on the safety of users may be pushed to them in real time, tailored to their precise location. An example is shown in FIG. 4. News can be filtered and pushed to a user based on their map position. News can be filtered and pushed to a user based on their map position being within a predefined distance of a specified latitude and longitude. News can be filtered and pushed to a user based on their map position being within a GeoFence.

An organization's own intelligence can be securely integrated and pushed to its users immediately—again, specific to their precise location. An example is shown in FIG. 5.

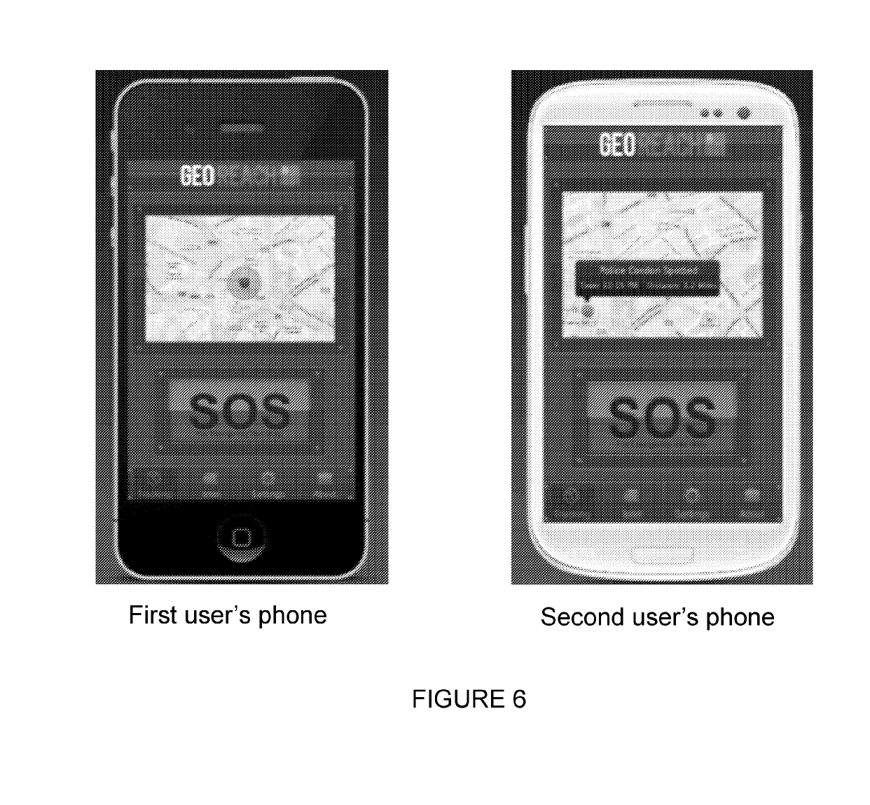

Users can also alert each other to potential dangers. For example a first user can drop a pin (i.e. place an icon on the screen, for example with some notes) and this can be received by the central system. At the central system the alert is reviewed, and if the alert is approved, an alert is transmitted and displayed on a second user's phone. FIG. 6 shows an example. In an example, a first smartphone is operable such that a first user of the first smartphone can send a location-tagged incident message to a central system for review, and if the alert is approved at the central system, an alert is transmitted to a second smartphone which is operable to alert a second user of the second smartphone to the location-tagged incident.

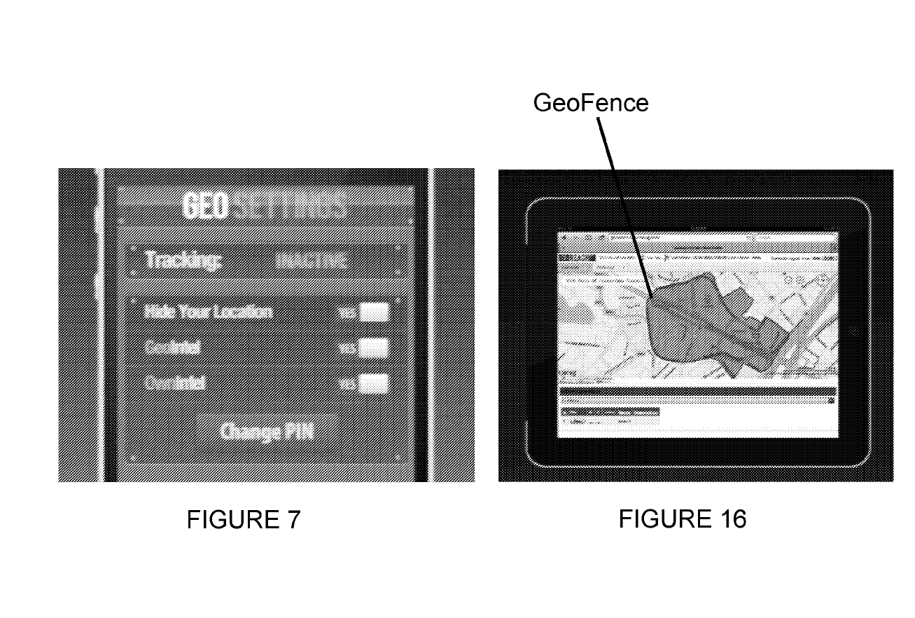

But, should privacy be required, users have the option to suppress their location—but all of the other GeoReach life saving functions, including the Distress Alarm remain active. On a mobile device, a screen may be provided in which such an option can be set. An example is shown in FIG. 7.

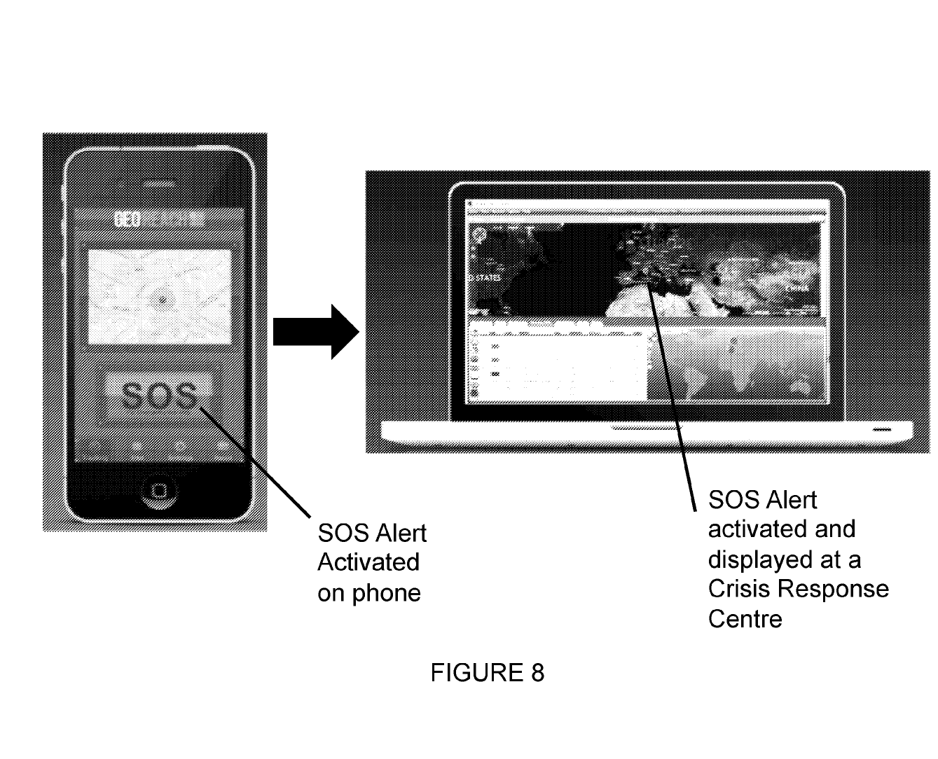

And should the worst happen, a user can activate the distress alarm. Within seconds our 24 hours per day, 7 days a week, 365 days a year Crisis Response Centre (CRC) or your own specialist Response Centre will be assessing the dangers and taking the steps which could mean the difference between life and death. In an example, an alarm is activated on a phone, and an alarm is activated and displayed at a CRC. An example is shown in FIG. 8.

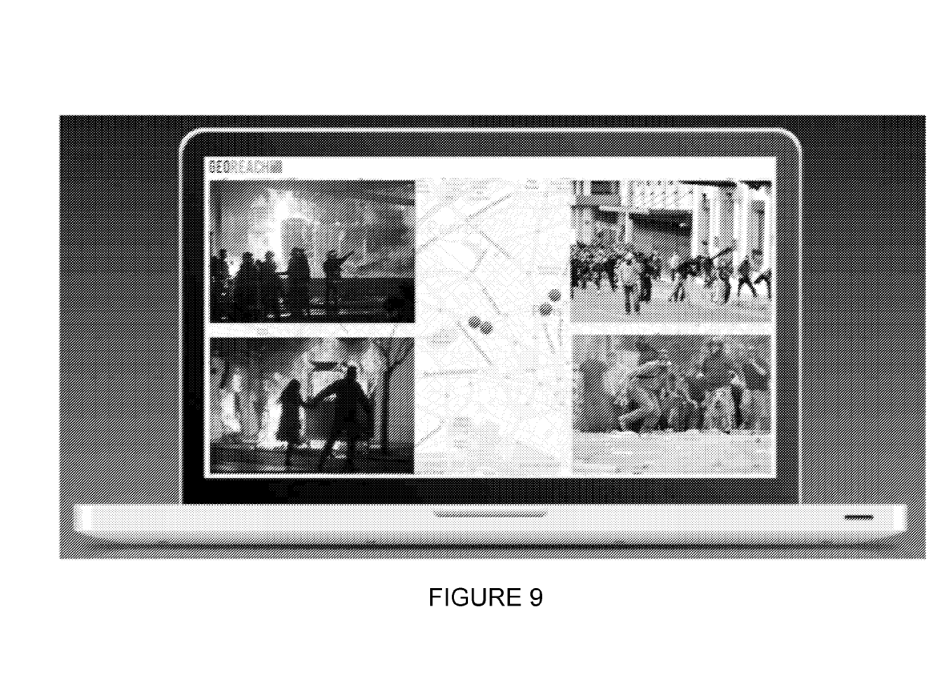

A user's mobile device may be programmed to automatically transmit images and audio to the crisis response centre, showing what is happening around the user. At the CRC, the images from multiple users may be displayed on a screen. An example of what may be displayed at the CRC is shown in FIG. 9, which shows images from four users.

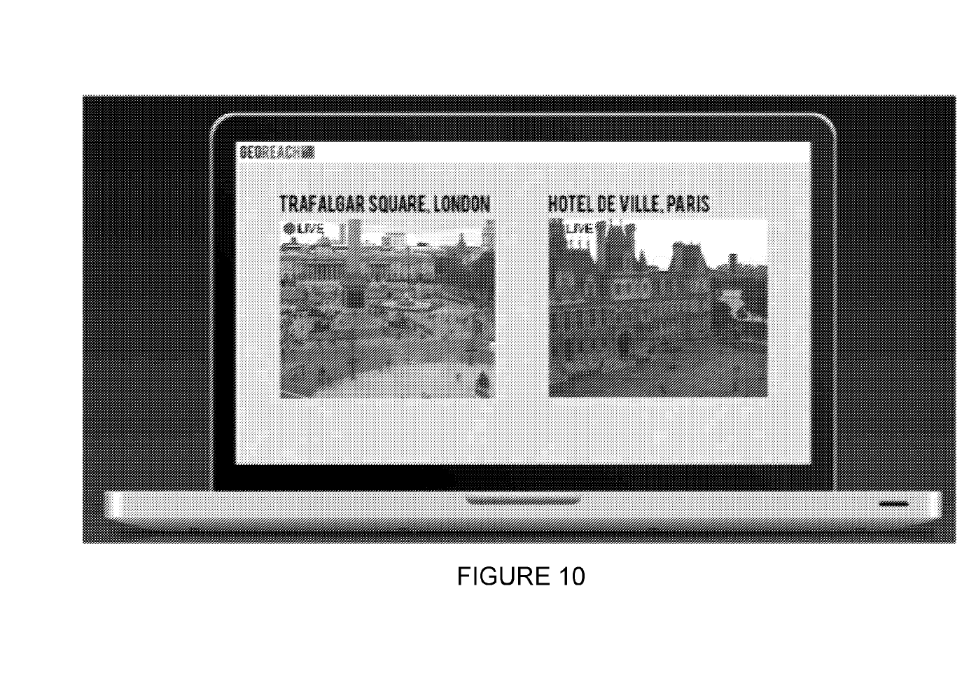

A Crisis Response Centre can even link directly to live closed circuit television (CCTV) footage of areas of concern to see how a situation is developing. An example of CCTV footage been shown on a client portal is shown in FIG. 10.

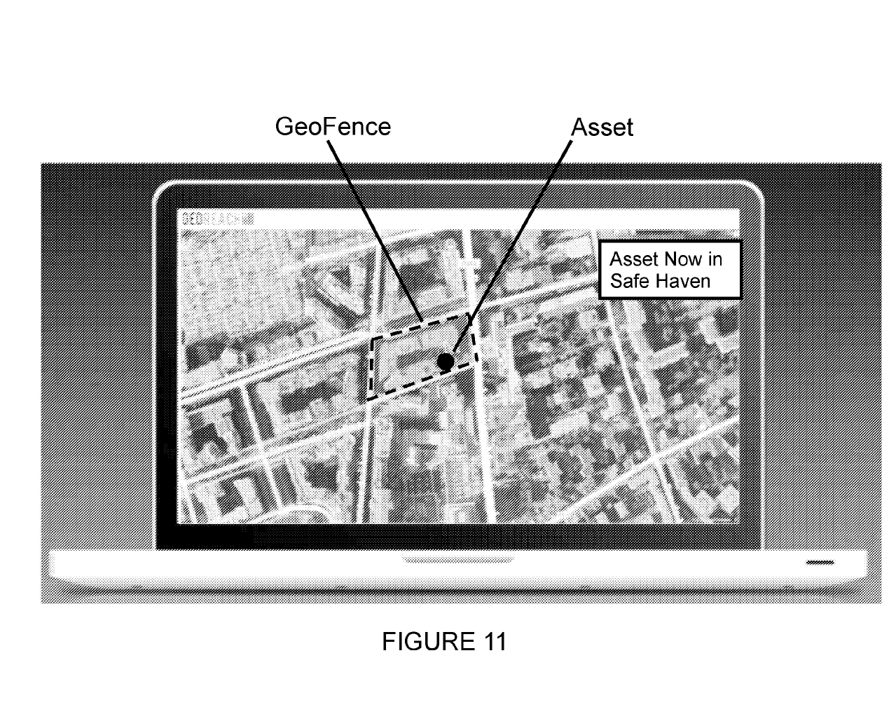

Using GeoFences, Georeach allows you to identify safe havens in otherwise hostile environments, and be alerted should a user either enter or leave these specific zones. GeoFences can also be used to highlight danger zones, automatically increasing the frequency of monitoring of users crossing one of these Geofences. In an example, a screen is displayed at a CRC when an asset enters a safe haven defined by a GeoFence. An example is shown in FIG. 11. A geo-fence is a virtual perimeter for a real-world geographic area.

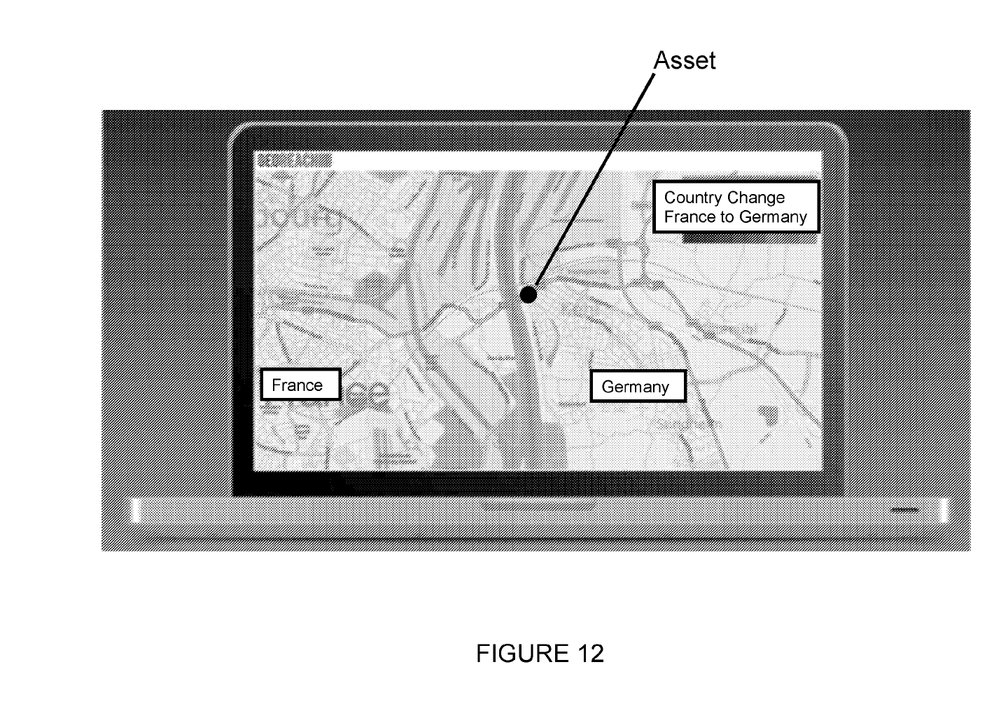

GeoFences can be used to generate an alert should any of your users or assets enter or leave a specified country, region, city or building. In an example, an alert is displayed at the CRC or on a client portal when a user enters or leaves a country. An example is shown in FIG. 12. An alert may be generated when a user enters a GeoFence region. An alert may be generated when a user exits a GeoFence. An alert may be generated when a user enters or exits a GeoFence. A GeoFence may have an associated temporal domain. For example, a GeoFence may only trigger an alert if it is crossed on weekdays between 8 am and 6 pm; this is an example of an inclusive temporal domain. Or a GeoFence may only trigger an alert if it is crossed at any time other than on weekdays between 8 am and 6 pm; this is an example of an exclusive temporal domain. A Geofence can be used to trigger an alert for a specified individual, a specified group of individuals, or for members of a specified organization.

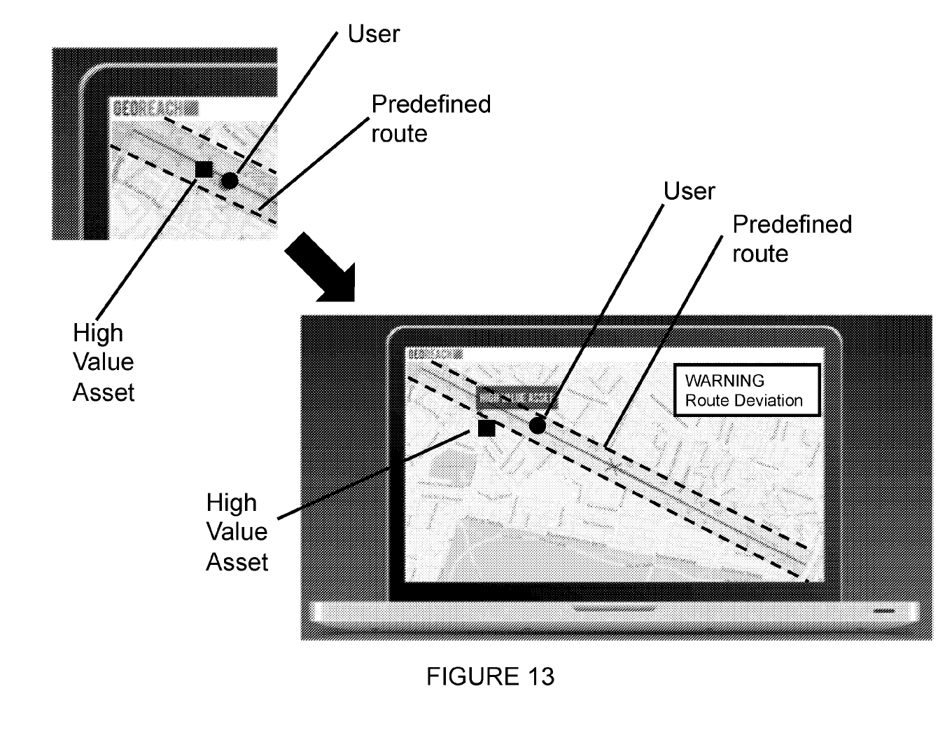

GeoReach allows you to know if a vehicle, asset or person deviates from a planned and timed route. GeoReach can also be used to notify you if, say, a valuable asset and the vehicle transporting the valuable asset are separated by more than a specified distance or if two or more specified users are similarly separated. In an example, an alarm is generated on a client portal when a high value asset deviates from a predefined route. An example is shown in FIG. 13.

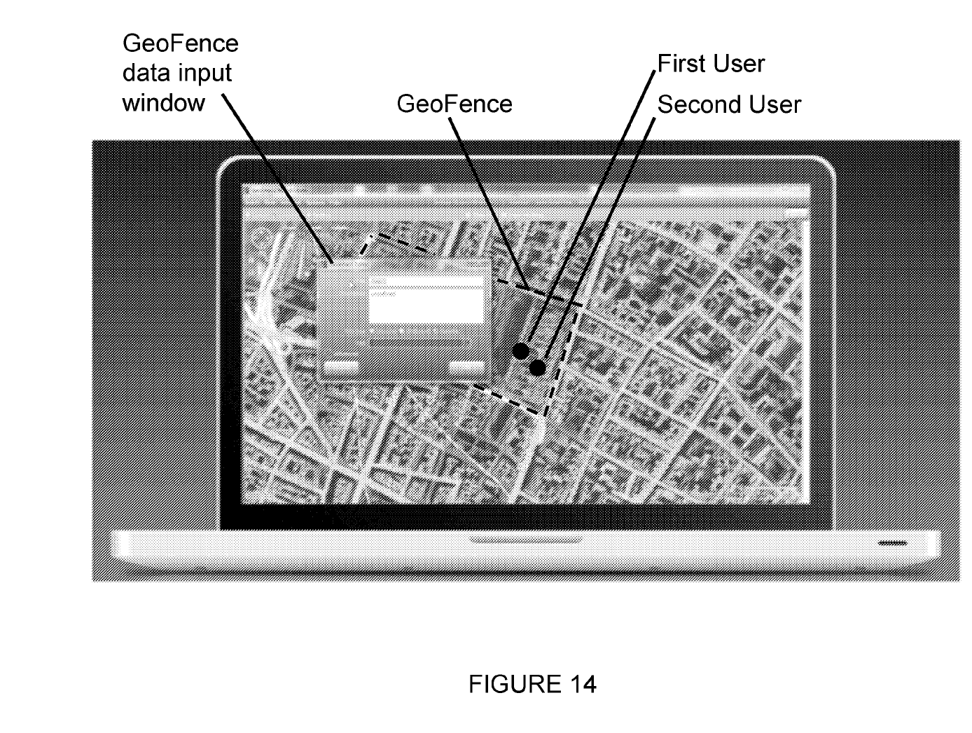

Should a crisis occur, our Crisis Response Centre (CRC) or your own specialists can quickly isolate the areas of concern—and immediately see who needs priority assistance. In an example (possibly in response to news of a riot) a GeoFence can be drawn around a particular area, enclosing one or a plurality of users who need assistance. An example is shown in FIG. 14.

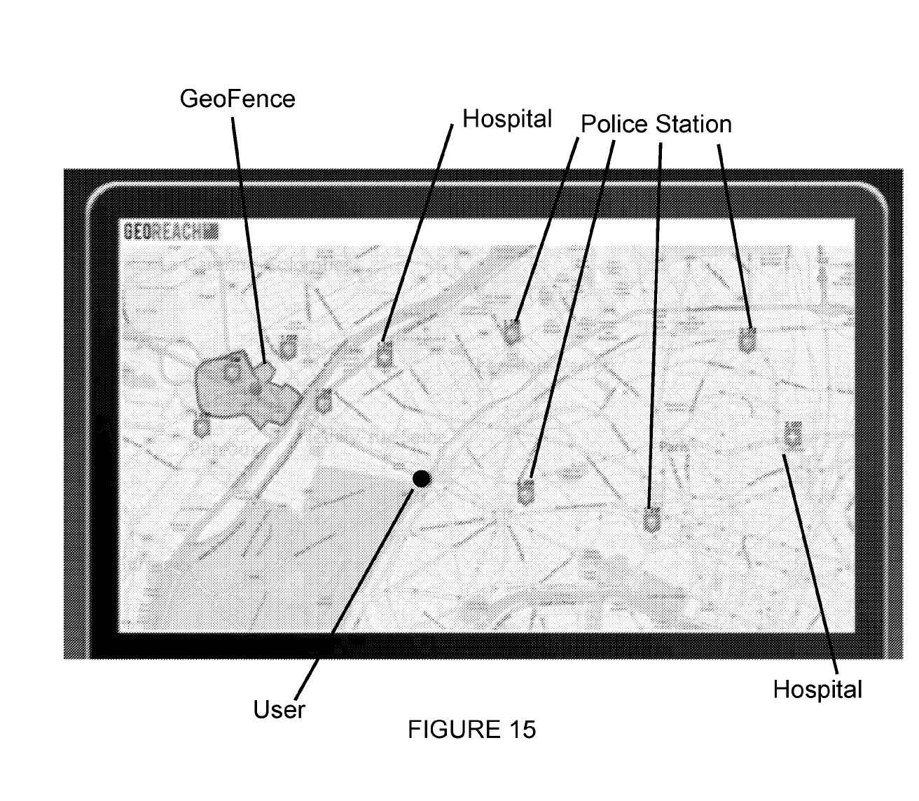

On the client portal, one can locate the nearest hospital or police station, by searching for hospitals or police stations. A designated type of building (eg. police station) may be searched for. An example is shown in FIG. 15.

And you don't need to be in a central location in order to access GeoReach. You can access the client portal (eg. over the internet) from any pc, lap top or tablet computer, such as an iPad, Windows, blackberry and android tablets—allowing your local security specialists on the ground to take control of a crisis as the crisis develops, close at hand. An example of a client portal on an iPad is shown in FIG. 16.

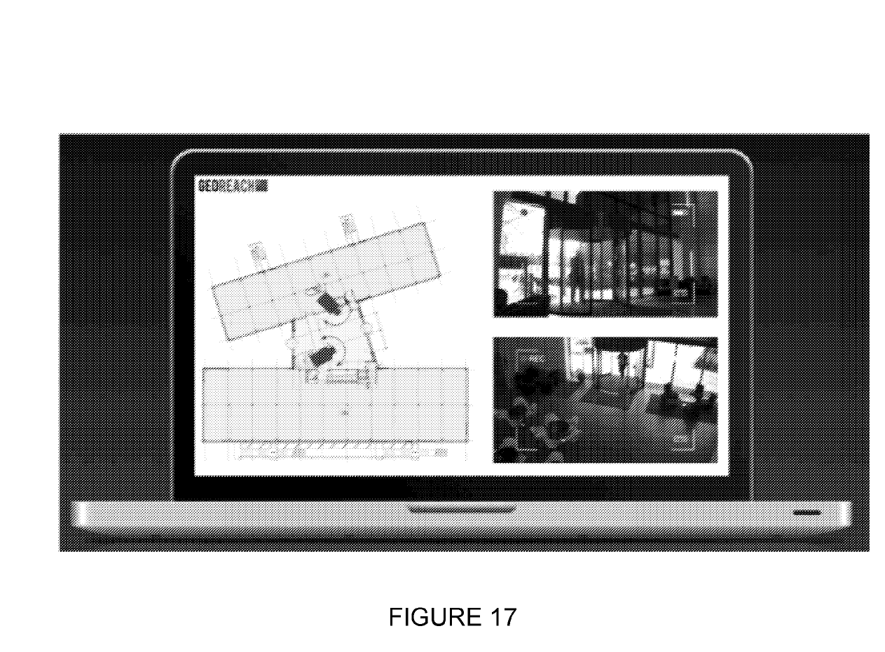

Using GeoReach you can assess the risk and see which of your people or assets need priority protection. GeoReach may work in parallel with your existing security systems. For example, you can access your existing web-based CCTV feeds or infrared systems through the GeoReach client portal. In an example, monitoring is performed from an operations room using a geofence, then someone crosses the geofence. On a different part of the client portal an alarm goes off. An operator can view the person who crossed the geofence through CCTV, then the operator can click on the building to see the building plan and users in different rooms. The client portal interface may include splitscreen, multi-angle, real-time views. An example is shown in FIG. 17.

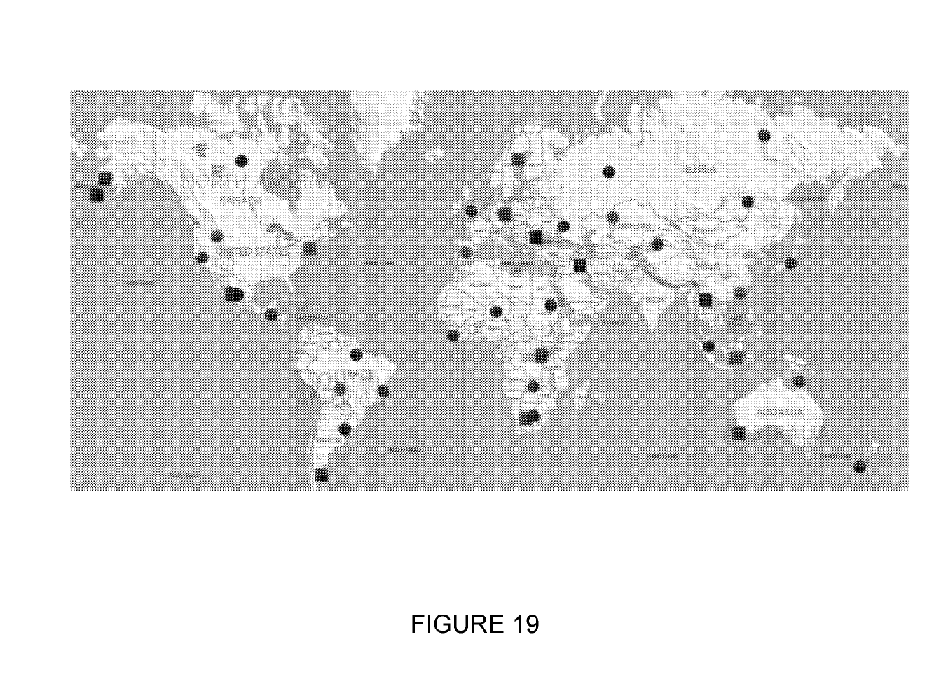

Georeach works on all major smart phone platforms, with minimal impact on battery life, on all networks in any country. Georeach doesn't stop working when you're out of mobile signal range. Georeach works with all major satellite phones and networks. We can even warn you when you're about to leave a mobile coverage area—and remind you to switch to your Georeach enabled satellite phone. In an example, in a client portal a world viewer can be displayed with a plurality of people in several countries being tracked. An example is shown in FIG. 19.

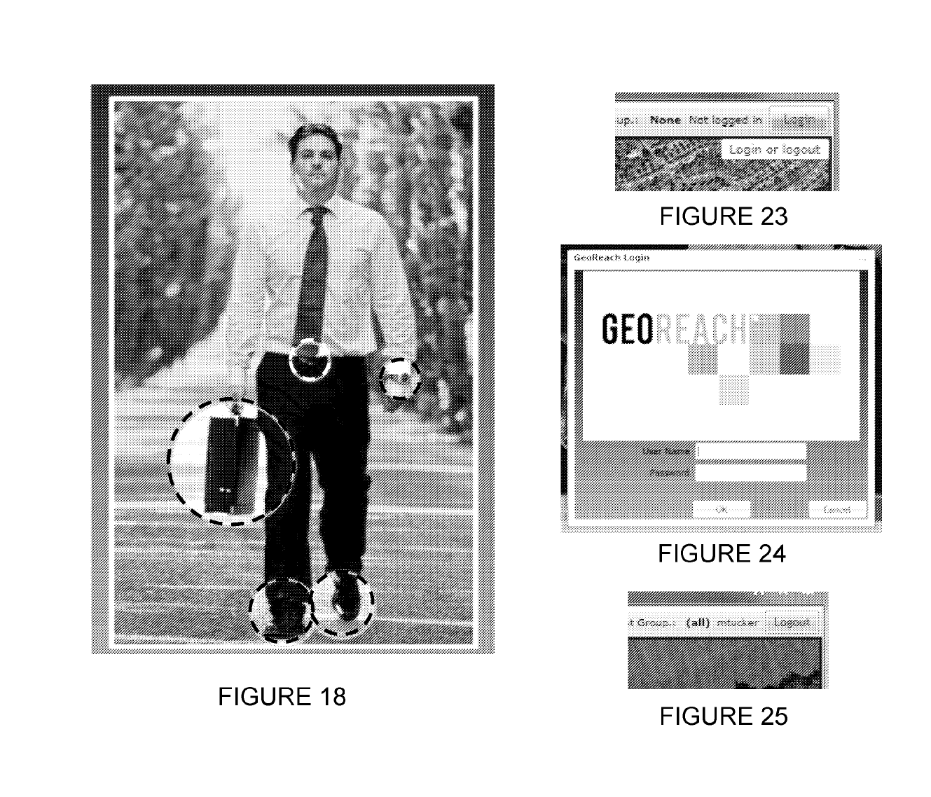

Georeach devices can also be embedded in bespoke and covert devices disguised, for example, in watches, shoes, briefcases, belts and jewellery. Georeach devices can also be hidden in items typically worn or carried by children and teenagers, where family protection is required. In examples a belt, jewellery and other GPS tracking devices can be used. Examples are shown in FIG. 18.

Your data is safe. No 3rd parties can access our database or are involved in processing your data. Our servers are kept in the impregnable former Bank Of England gold bullion vaults.

Taking immediate action in a crisis may be essential—it's often the difference between life and death. Georeach enables you to take informed and early action in any crisis. In an example of key features, a news alert comes in about a riot, a GeoFence is drawn round the area, one of three users within the GeoFence notifies the others of a specific aspect of the riot, one of them presses the distress button, the CRC receives photos and audio of what is happening around him, the CRC notifies him of a nearby police station or other safe area (which could also be GeoFenced as a safe haven), and the user gets to the safe haven and deactivates his distress button. The client portal interface may include splitscreen, multi-angle, real-time views.

GeoReach is the future of personal and asset security.

GeoReach provides a distributed monitoring (or security) system, which allows devices (or users) to be paired. The system may tell you if paired devices (or users) become separated. In the system, devices may be grouped by multiple pairings. The system may create an alarm if paired devices (or users) become separated from a predefined route.

GeoReach provides a distributed monitoring (or security) system, in which a geofence can be created that immediately identifies who is in an area. Creating a GeoFence allows you to:
quickly identify who is in an area.
raise alerts whenever a user enters (or leaves) a given area.
Allow alerts to be raised if a user doesn't reach a certain area within a certain time-frame.
Allow time-based alerts to be raised if a user is still within the fence-area within a certain time-frame.

GeoReach provides a distributed monitoring (or security) system, in which battery charge may be saved by kicking-in GPS only just before a location-reporting signal is about to be sent. So a GPS receiver may be activated and deactivated a multiplicity of times, each time corresponding to a location-reporting event, which saves battery compared to navigation in which a GPS receiver may be activated at all times. However, the GPS receiver is used more than in a single reporting of position, for which the GPS receiver needs only to be activated and deactivated once. Battery level can be monitored remotely eg. to see if user lets their battery level get too low too often. A battery use history report can be provided on request. Alternatively a battery use history report can be provided regularly, eg. once per month.

GeoReach provides a distributed monitoring (or security) system including a plurality of mobile phones, in which geofences are definable. The mobile phones may be from a plurality of mobile platforms. The mobile phones may run a plurality of different operating systems. A mobile phone user can suppress their precise position, but alarms remain active; however a GSM country code may still be available, so some crude position data may remain available. Integration is possible between the system and an existing security system (eg. a CCTV system), or between the system and available camera (eg. webcam) feeds. Hyperlinks may be provided on a map to available camera (eg. webcam) or CCTV feeds. An alarm may be triggered when a phone is measured to be traveling too fast. An alarm may be triggered when a cross-country boundary event is logged (eg. a GSM country change, or a physical boundary crossing). Some alerts may be generated at a central location, not on a user's phone; then parties on a list may be notified. An alert signal may be generated if a signal is not received within a predefined interval. In a central user interface, a single click on an entry identifying a user automatically displays the last known user position in the central user interface. In a central user interface, a route to be used in Georeach monitoring can be defined. In a central user interface, a geofence can be defined by freehand drawing. In a central user interface, a geofence may have a hyperlink for use in risk analysis. In a central user interface, Fences, Devices and Users can be expressed as a single object:{Fences+Devices+Users}, which can be further integrated (e.g. using hyperlinks to local IT-systems) with other information-sources such as a Company Human Resources Database, a Travel-Itinerary and Third-party Risk-analysis information. In a central user interface, discontinuous geofences are provided because discontinuous geofences are supported. For example, two separate sites which are not physically joined may be defined as a single geofence. In a central user interface, a colour code may be used to denote if the most recent signal was sent during daylight (eg. a yellow dot is used) or at night (eg. a black dot is used). A geofence can be defined to be time-dependent eg. for a workplace a geofence can be defined to be between 8 am and 6 pm, so entrance or exit from the geofence is only monitored during this time interval. In a central user interface, newsfeeds are filtered by location.

The GeoReach system may be one in which a user is able to create one or a plurality of GeoFences, such as in or around their own (or local) location, that can then be authorised centrally and used to help to monitor other users. The GeoReach system may be one in which a user is able to create a news-item that can then be sent to the central system, approved, and then passed down to other, tracked users.

GeoReach provides a distributed monitoring (or security) system including a plurality of mobile devices, in which incoming messages are queued in a message gateway of the monitoring (or security) system. For the queued messages, lookup of cell towers (if required) can be performed as a background process.

GeoReach provides a distributed monitoring (or security) system including a simulation system in a central system. The simulation system may include a route simulator. The simulation system may include a route calculator. Externally-generated routes may be imported into the route simulator.

The GeoReach system provides several types of alerts. One type is signal discrepancy. This when the user or asset is measured as having travelled too far in a time period ie that they have been measured as having exceeded a predefined speed threshold. A speed threshold may be defined with respect to an expected transportation type eg. walking, car, truck, helicopter, aeroplane. The alert may be flagged to a CRC or to a client portal. Measured positions may be characterized by a latitude, a longitude and by a horizontal accuracy. If a fast movement is recorded, but this is within a level of uncertainty, i.e. if it is not certain that a speed threshold has been exceeded, then an alert may not be generated.

An alert can be generated corresponding to a possible border crossing event. This can correspond to a measured crossing of a border, or the alert can correspond to a change in nationality of a cell tower being used, which may not correspond to a physical border crossing, but which may be an indication of a possible physical border crossing. For example, it is possible to detect a French mobile phone mast from near the English south coast, but this does not mean that a user has certainly crossed the border from England into France. An alert may be generated at a central monitoring location, not on the mobile phone. When such an alert is generated, parties on a list can be notified.

An alert may be raised if two paired devices no longer appear to be traveling together. A complication is that two paired devices are not usually synchronized in their sending of position updates. One way to deal with this is when a first device reports its position and uncertainty, to investigate if this reported position and uncertainty is consistent with the extrapolated position and uncertainty of the second device based on its two previous reported positions and uncertainties. Another way is when a first device reports its position and uncertainty, to interpolate the position and uncertainty of the first device based on its present and previous positions to the time at which the second device last reported its position, to see if that interpolated position and uncertainty of the first device is consistent with the reported position and uncertainty of the second device at that time.

An alert type is one in which a device or one of a set of grouped devices departs from a route. In this alert type, a route is predefined, and a threshold offset distance from the route is predefined eg. 20 m. An alert is raised if a device or a device in a set of devices is recorded as being off route by more than the predefined offset distance, where position uncertainty of the device position is also taken into account. So in an example, a device position may differ from the route by more than the sum of the predefined offset distance and the position uncertainty for an alert to be generated that a device is off route.

Uses of an alert that paired devices have become separated or that one device or one device in a group of devices has gone off route include: courier tracking applications, tracking members of families, tracking children with respect to their minder, checking that vehicles in a convoy stay in that convoy, pairing one individual or a plurality of individuals with a vehicle, checking that an individual and their bodyguard do not become separated, monitoring the performance of a bodyguard in guarding the person they are looking after (eg. what is the maximum distance the bodyguard allows between the individual and the bodyguard).

An alert may be generated when the mobile phone mast (eg. Global System for Mobile Communications (GSM)) being used for communication changes from one in a first country to one in a second country.

Alerts may be generated only once until closed, such as by an administrator, such as at a central monitoring facility, or on a client portal, rather than repeatedly generating alerts.

An alert may be generated when a device position is recorded as having crossed from one country to another; device position uncertainty may be allowed for in this determination, so that an alert is only generated after allowing for device position uncertainty. That is, a device position may be recorded as having entered a different country, when the distance from the international border in the new country is greater than the lateral uncertainty in the device position.

In an implementation, the GeoReach system can be used to check whether individuals or mobile assets are inside or outside a Geofence. For example, in the Algeria gas plant terrorist attack of January 2013, for many hours after the attack was over, security services were still checking the gas plant to see if they could find missing people, because the security services believed that individuals could still be hiding in the plant, fearing for their safety. In the GeoReach system, a Geofence could be defined around the extremities of a site (eg. the gas plant site), and then instantly the system can report if the last reported position of the person was inside or outside the GeoFence. The GeoReach system would then indicate or report if a search was required or not for individuals in a given set of individuals.

The GeoReach system can be used to plot a trail of a user on a map based on their measured places and associated times. To see the latest place of a user, the GeoReach system identifies the latest signal from a device of that user. One device, or a plurality of devices, may be associated with a particular user. In the user interface, the name of a user, or part of a name of a user may be entered, and matching entries from the known users (eg. in a large list) are displayed. Users may be split up into groups of users. When viewing a list of users, an administrator can decide which alerts to close in that list. The known users can be searched by country for the users in a country. On a map display, the users shown can be colour coded to display if the most recently received signal from each user was sent during daylight hours where the user is recorded as being, or whether the most recently received signal was sent during the hours of darkness where the user is recorded as being. A point or trail on a map may fade in relation to the time since the related position data was received. Multiple users may be shown on a map. The trails of multiple users may be shown on a map.

When a world map is shown on a user interface, such as shown in FIG. 19 for example, the map may scroll from left to right (or from right to left), consistent with the equator being a continuous line. Hence the world scrolls round the screen from left to right (or from right to left).

When a device is reported as lost, a report may be generated in the user interface which reports the last known position of the device.

A type of alert may be generated if a signal has not been received from a user (or a device) within a predefined time interval. In the user interface, a single click on a user name, displays on a map the last known position of the user. In the user interface, a single click on a device identifier, displays on a map the last known position of the identified device.

A Geofence can be defined in a map user interface in ways such as in any of the following ways. A GeoFence can be defined by a position point and a radius, thereby defining a circular GeoFence on a map. A GeoFence can be defined by a route, together with a predefined or user-definable width of the GeoFence in relation to the route. A route comprises at least a start and a destination, and a plurality of route segments which define a continuous path from the start to the destination. A GeoFence may be rectangular, defined by a position point, a width, a breadth, and optionally a rotation angle. A GeoFence may be drawn freehand on a map, such as by using a mouse and mouse clicks to define points which make up the GeoFence, or cursor control keys and a return key, or using a touch screen, to define points which make up the GeoFence. Boundary points which make up a GeoFence may be edited in a user interface, such as to change the shape of a GeoFence for example. A GeoFence may be defined by geographical shapes. An example is using an expressway (or motorway) as a GeoFence, such as the M25 motorway which encircles London, UK. Another example is using the boundary of the Tokyo Metropolitan area as a GeoFence. Another example is using the “beltway” expressway around Washington, D.C., USA. Created GeoFences may be saved in a database. A defined GeoFence may have an associated hyperlink, for example for use in risk analysis.

In an example, a first bomb goes off in a location in a city. In a user interface (eg. at the CRC, or on a client portal), an analyst selects a GeoFence centred on the first explosion location, with a 1 km radius. Soon after, a second bomb goes off within 500 m of the first explosion. In the user interface, an analyst selects a GeoFence centred on the second explosion location, with a 1 km radius. In the user interface, the analyst selects to combine the two GeoFences into a continuous area, with unnecessary portions of the GeoFence within the combined GeoFence area being automatically removed. Hence a GeoFence has been edited and enlarged in response to incoming news.

A Geofence can be discontinuous. In an example, if the second bomb location in the previous example had been 3 km from the first bomb location, the combined GeoFence relating the first and second bomb locations would be two circles each 1 km in radius, with the circles separated by 1 km at their points of closest proximity. This is an example of a discontinuous GeoFence.

A discontinuous GeoFence comprises a plurality of non-intersecting continuous GeoFences.

A GeoReach system can include a message gateway, for queuing incoming messages. Incoming messages may report data relating to device position. The message gateway may queue messages for typically up to 5 s. Queuing at the message gateway ensures that data in incoming messages can be fully processed: therefore messages are not lost without processing, or only partially processed, due to system overload. For example, if an incoming message has no GPS data, because for example a user is inside a building, data in the incoming message relating to cell tower ID can be looked up in a cell tower database within the system. If the cell tower database within the system does not provide a positive result, an external cell tower database can be consulted, such as over the internet. Because this process can take a few seconds to execute, it is advantageous to queue any other incoming messages received during the lookup process, so that these queued messages can be processed later. Lookup of cell towers in cell tower databases can be performed as a background process. A Structured Query Language (SQL) Server, eg. a Microsoft SQL server, may be used for storing and retrieving data in the cell tower database within the system.

An example process for processing incoming position data is as follows:

Step 1—If we already have a latitude & longitude (e.g. from the Device), we move straight to Step 5.
Step 2—We do look up Cell towers against our own “internal database” of previous signals received, to see if we can generate a latitude & longitude, and if we can, we generate a latitude & longitude.
Step 3—If step 2 fails, we look up against our own cached-copy of the free OpenCellID database (from http://www.opencellid.org/) and also OpenBmap (from http://openbmap.org/) and generate a latitude & longitude.
Step 4—If step 3 fails, we perform an external lookup to http://www.location-api.com
Step 5—If the above Steps 2 to 4 fail, we carry on (noting that a signal has arrived but we are unable to display it on a map).

Steps 2, 3 and 4 may be performed as part of a “background process” by the database server (usually within a few milliseconds to a few seconds), or they may be performed in a central system. These processing tasks are held in a local queue and are asynchronous.

A GeoReach system can include a simulation system. The simulation system may be used for testing the system. The simulation system may be used for training users of the system. The simulation system may be used for scenario testing, in which the system can be used to simulate scenarios, such as major terrorist attacks. The simulation system can be fully automated. Locations in the simulation can be user-defined. A predefined route can be used in a simulation. The GeoReach system may have an internal route simulator. Simulated routes may be created outside the GeoReach system, and imported to the system. An example is a simulated route generated using Microsoft MapPoint or Microsoft Bingmaps including defined time offsets and positions along the route. Such a route may be exported from Microsoft MapPoint or Microsoft Bingmaps. (Alternatively, the GeoReach system may provide a user interface in which a geofence or journey can be obtained by interaction with, or by integration with, journey-planning software such as Bing-Maps/Mappoint). The GeoReach system can run a simulated route, which starts at a user-defined time. In a simulation, two imported routes can be used: a first route and a second route which contains a deviation with respect to the first route. The first route may be used in the GeoReach system to define a GeoFence for the route. Then the second route may then be simulated in the context of a GeoFence defined with respect to the first route. The simulation can be used to verify that the system generates an alert as intended when the second route deviates from the GeoFence defined by the first route. The example of FIG. 13 may relate to a simulation system. The system can be used in user training to show what is expected to occur when a device travelling on a route deviates from a planned route. The simulation system can be used to train staff who are required to travel on a given route, so they know what will happen if a route deviation occurs. The simulation system can be used to demonstrate the GeoReach system, to deter criminal acts.

The GeoReach system provides a system for tracking a plurality of devices, and which may further integrate other information, eg. for managing a response to a crisis. A World Viewer software application may be provided which lets you see in one window on a computer screen where all the tracked people or devices are. A GeoFence may be created which bounds a defined area. A plurality of Geofences may be created. A tracking application may be provided for mobile devices. An application may be written for each software platform of the mobile devices.

A GeoReach system may include: an application on a mobile device, configured for the software platform of the mobile device, the application reporting location-related data to a central server; the central server, which processes the received location-related data intelligently (eg. removing GPS spikes), and presentation of analysis performed at the central server, such as in a control centre, or on a client portal which can be viewed remotely.

Note that some people have more than one mobile phone. For example, they may have a normal mobile phone, and a satellite phone. They may also have one or more covert devices. A plurality of devices can be grouped for an individual user eg. a regular mobile phone, a satellite phone and a covert device can be grouped for an individual user. Devices of different types can be paired or grouped.

The application on a mobile device can be operated to generate an SOS alert. The SOS alert will appear at the control centre in less than one minute from its generation at the mobile device. Such an alert can provide an audio alert and a visual alert. In a standard procedure, the SOS alert remains active until the user that initiated the alert cancels the alert on their mobile device. However, it may be possible to reset the alert from the control centre, eg. by using an SMS email alert to an administrator, or automatically from the central system.

A country change alert can be used to notify a CRC, so that a CRC can review it. A CRC (or a user on a client portal) may review an intelligence report from a user, and if it is approved, the intelligence report can then be pushed out as intelligence to other users.

The client portal may be accessible via the internet, such as via a web browser program. The web interface may use Microsoft Silverlight. A login page prompts a user for their username and password, which have been registered at the CRC. After login, the user is provided with a map of the world showing the current locations of the users registered in the group corresponding to the login account. Client-specific content may be overlaid on the map. For example, the basic map may be a publicly-available map such as provided by Bing maps or Google maps. Client-specific content may include the internal layout of a building or of an enclosed site; such information may not be publicly available. For each user, data displayed in a list of users below the world map may include present country of location, phone number, user name, data type of the location signal received (eg. GPS, phone mast, wifi location), the time it was received in a standard time zone (eg. GMT). For each user, a trail of their recent locations may be plotted on the map. The trail may be over a prescribable recent time period, eg. the previous 30 days. The trail may get dimmer going back into the past. Newsfeeds (eg. CNN, BBC, Reuters, Al Jazeera) may be displayed on the map relating to the location of a selected user ie news stories can be filtered to the location. News stories may be filtered to within a prescribable distance of the user's location eg. a 50 km radius. The map may be searched for specific institutions (eg. hospitals, police stations, military bases), and the results may be displayed on the map, such as by plotting related icons on the map.

An alert may be sent from the client portal or from the CRC to all users within a defined GeoFence. The alert may be sent in the form of an SMS.

In the user interface, countries or geographic regions may be graded by risk level. The risk level may be one provided publicly, such as by the US Central Intelligence Agency (CIA). The monitoring frequency of user devices may be increased in relation to greater country risk level.

In an example, an application on a mobile device provides a photo to the CRC at a prescribable time interval. For example, if the SOS alert has been activated by the user of the mobile device, a photo can be sent to the CRC every minute. Delivery method is user settable at the mobile device, and can be using https, http or SMS for example. If an SOS alert has not been sent, a photo may be sent at a prescribable time interval, such as every minute or every hour. The frequency of sending may be increased in correspondence with a higher country risk level. The photo sending application may run in the background on the mobile device.

When an application on a mobile device which communicates between the mobile device and the CRC is run, there may be a setting on the device to determine if the device should send position notifications to the CRC. There may be a setting on the device which controls the time interval between position notifications eg. once per 5 minutes. A SOS alert button may be provided in the device's main menu. The application automatically restarts on a device reboot.

An operator at the CRC may request an audio feed from a specified mobile device. An operator at the CRC may request a feed of photographic images (eg. once per ten seconds) from a specified mobile device. An operator at the CRC may request a feed of video images from a specified mobile device.

One or more geofences may be pushed to a mobile device, for example from the central system.

One or more nearby contacts may be pushed to a mobile device, for example from the central system.

### GeoReach WorldViewer

### Introduction

This section describes the features of GeoReach™ WorldViewer, a web-based application that enables permitted users to observe the current, and recent, geographic positions of their tracked assets. An asset can be either a person who is carrying a mobile phone with the GeoReach™ Tracker app installed, or it can be an item that has a tracking device attached to it.

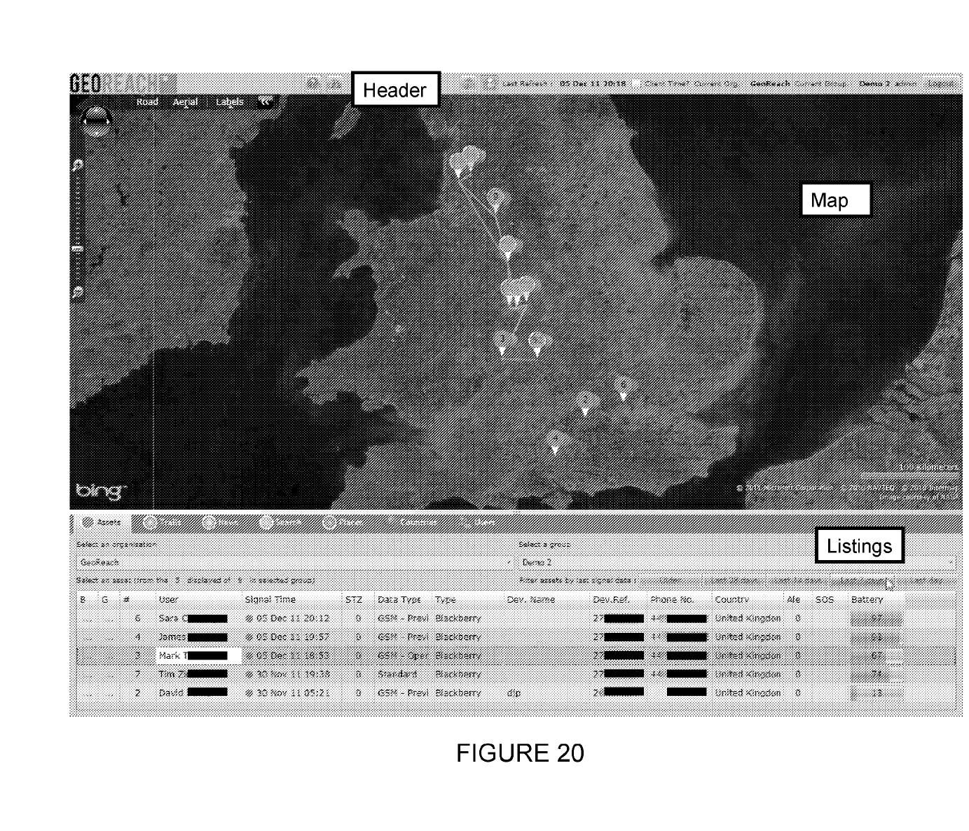

GeoReach™ WorldViewer is run from within your standard browser on eg. a Microsoft Windows or Apple Mac laptop/PC, so there is usually no need to install anything (e.g. as long as you have the popular Microsoft Silverlight present). GeoReach™ WorldViewer provides the ability to oversee your assets, conveniently split into groups, so that you are constantly aware of their location in the world, and whether there are any alerts tagged against them. Alerts can be raised by a mobile phone user pressing an SOS sequence, or because they have travelled into an area considered to be a higher risk level. FIG. 20 shows an example of output from WorldViewer. User most recent positions are shown on a map, together with tracks of their recent movements. A list is provided of a group of users. For each user, their name, number, their most recent signal time, their local time zone time offset with respect to GMT, the type of position data received, the device type, a device Name, a device reference, a device phone number, the country in which the device is currently present, whether or not an SOS alert has been raised, and the battery level, are shown. User positions, user trails, newsfeeds relating to a selected user's position are displayable on the map.

### Overview

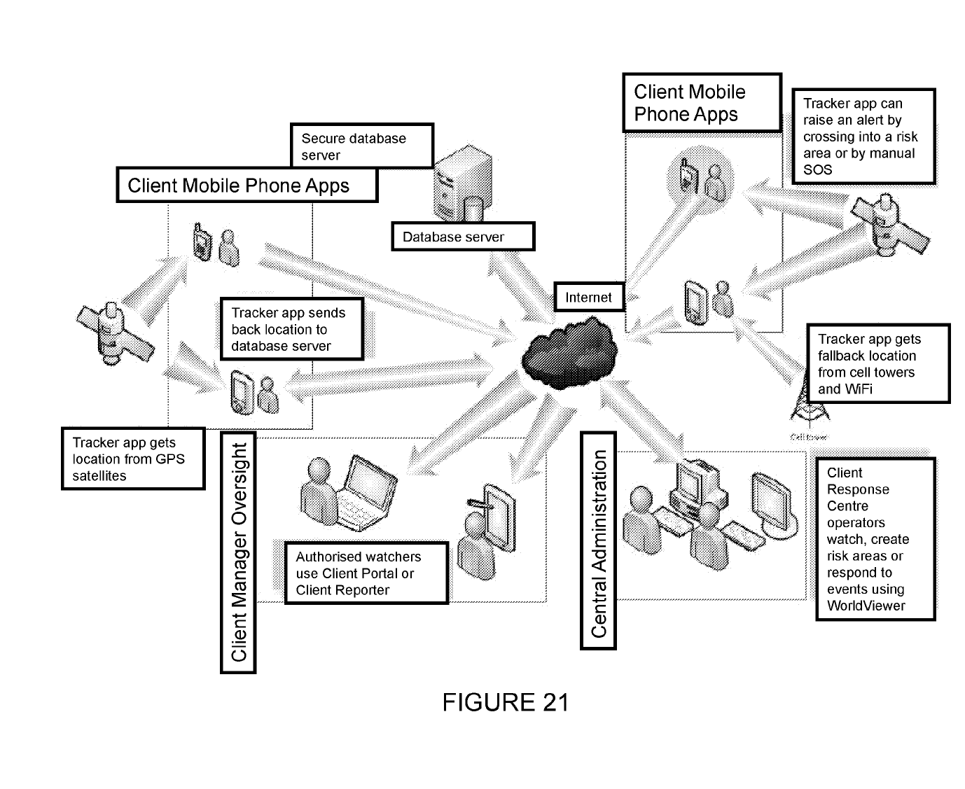

All organisations have assets that they want to know where they are now, or where they have been recently. These assets could be a person with a tracked mobile phone or an expensive item that has a small device attached to it. GeoReach™ have developed small apps for mobile phones and tracking devices that can send their geographic location back to a central secure database. GeoReach™ Client Response Centre can monitor, create risk areas, and respond to events using GeoReach™ WorldViewer. Other authorised GeoReach™ WorldViewer users can observe these asset locations via a web browser on a Windows PC or Apple Mac anywhere in the world. FIG. 21 shows a schematic diagram of an example of a monitoring system. In an example GeoReach Tracking System, a GeoReach secure database server is provided. A GeoReach Tracker app can raise an alert when a predefined risk area is crossed into, or when an SOS alert is manually activated. A GeoReach Tracker app gets location data from cell towers and WiFi sources. GeoReach Client Response Centre operators watch, create risk areas, or respond to events using GeoReach WorldViewer. Authorised watchers login via a network connection or via the web using GeoReach Client Portal (or GeoReach Light) to view tracking information provided by the GeoReach Tracking System. GeoReach Tracker apps get location information from GPS satellites. GeoReach Tracker apps send back location to the GeoReach database.

The GeoReach™ WorldViewer application is split into three main areas, Header; Map and Listings, so that you can see locations and related information easily. See FIG. 20 for example.

Header: Buttons to login or logout; refresh the location and news listings; find a place. A tickbox to switch the time display between our database on Greenwich Mean Time, and your workstation client time zone. Displays your currently selected organisation and group.

Map: Purple numbered markers displaying the last known geographic location of each asset in the list. Assets with a current alert have a red circle around them. Green numbered markers joined by green trail lines for each previous geographic location of the selected asset. Orange labelled markers at the approximate geographic location of each news story from a selection of news feeds. Pink numbered markers for each item returned by your latest search. Brown numbered markers for each place found by you.

Assets Tab: All assets, in your selected organisation group, that can be filtered by the date of the last signal received from the tracking device.

Trails Tab: Previous signals received from the tracking device, of the selected asset, that can be filtered by number of days prior to the last received signal.

News Tab: Latest news items from a variety of news feeds that have been tagged to geographic locations.

Search Tab: Button to search for a type of location, such as a hotel, hospital or airport, near to the centre of the map or at a specified geographic location.

Places Tab: Button to find a place, address or latitude, longitude co-ordinates.

Countries Tab: A listing of each country in the world to enable you to find them easily, and to read about them in the CIA World Factbook or Wikipedia.

You can click and drag the horizontal bar between the map and listings to change the amount of space allocated to each panel. You can double click the horizontal bar (or the GeoReach logo) to toggle the visibility of the listings panel.

### Logging In

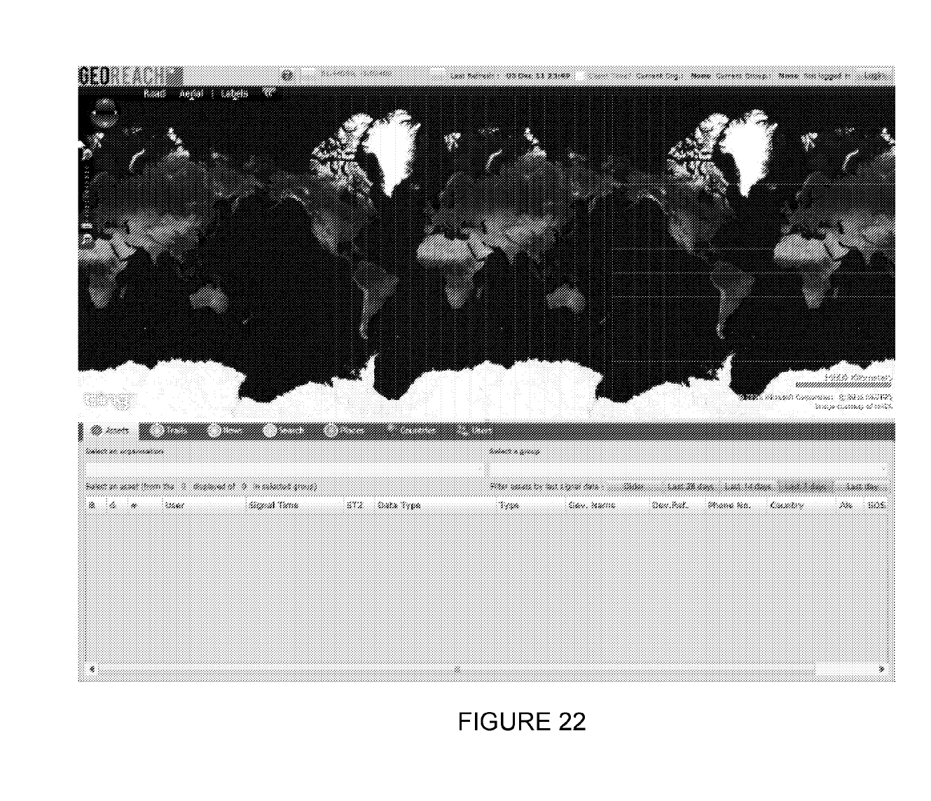

GeoReach™ WorldViewer will not initially display any information because a user needs to login first. An example is shown in FIG. 22. All users of GeoReach™ WorldViewer should login first. The Login button is in the top right corner of the browser. An example is shown in FIG. 23. This button will open the GeoReach™ Login dialog. An example is shown in FIG. 24. If you enter a verified User Name and Password, then the Login dialog will close and your login name will be displayed to the right of the button which will now be labelled Logout. An example is shown in FIG. 25. The permission of your User Name will control the Organisations and Groups that you are allowed to see.

### Refreshing the Data

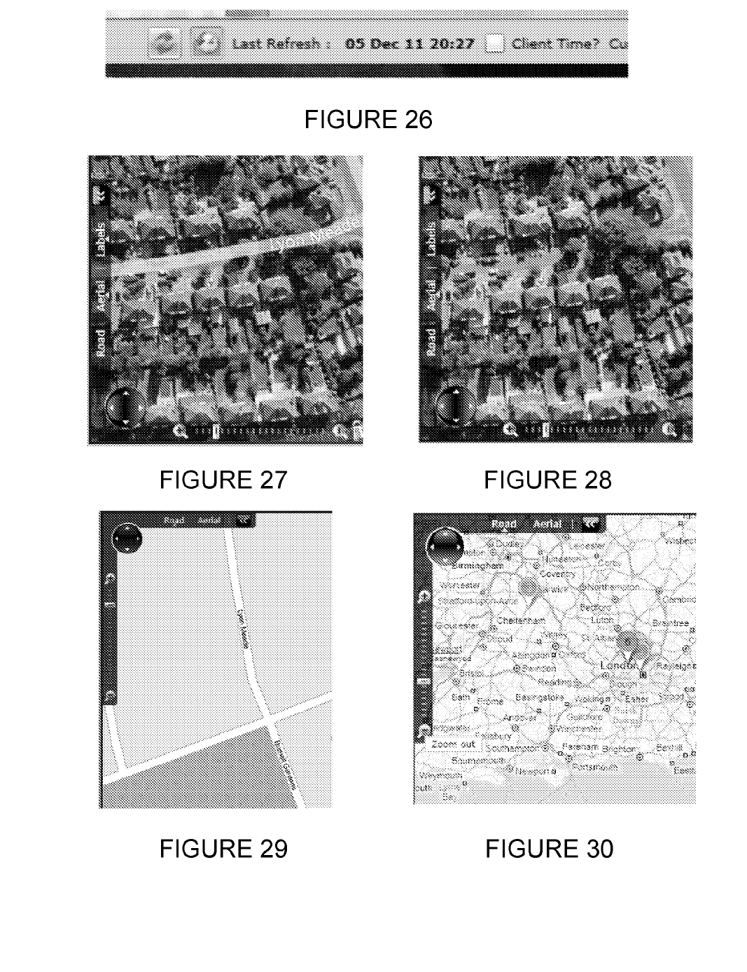

By default, the data (Assets, Trails, News and Users) will be refreshed every 5 minutes. However, you can toggle the automatic refresh on and off with the AutoRefresh button (clock and green arrow). You can always press the Refresh button (blue arrows) at any time. An example of refresh time information is shown in FIG. 26. The timestamp of the Last Refresh is displayed to the right of the Refresh and AutoRefresh buttons.

### Using the Map

The map provides the backdrop to the geographic position of all of the tracked assets.

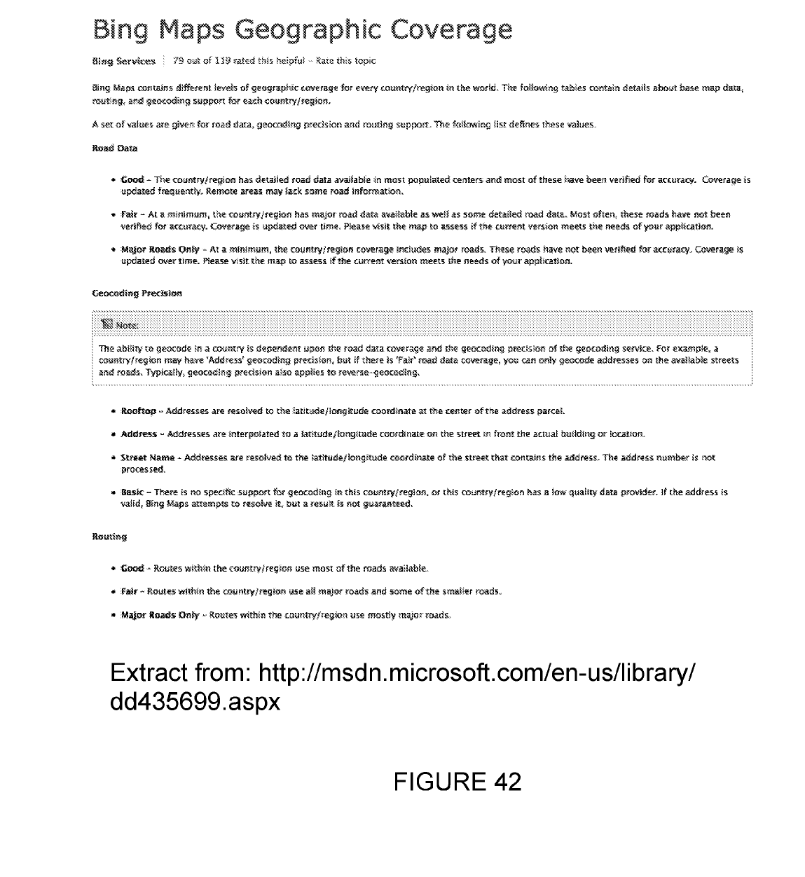

GeoReach™ WorldViewer incorporates Microsoft Bing Maps as the mapping background because of its ease of use and detail in most parts of the world. You can read about the geographic coverage of Bing Maps at http://msdn.microsoft.com/en-us/library/dd435699.aspx. See FIG. 42 for example. However, we realise that there are some parts of the world that are better covered by Google Maps, so we provide a column labelled G on each of the listing tabs. In addition, we provide a column labelled B on each tab to open the online edition of Bing Maps which includes the ability to calculate routes and has Bird's Eye view.

Map Types. You can change the map type between Road and Aerial using the map menu in the top left corner of the map. The Aerial map can be displayed with or without Labels. An example with labels is shown in FIG. 27. An example without labels is shown in FIG. 28. The Road map always displays labels, but you cannot see the buildings or their plots. An example is shown in FIG. 29.

Panning and Zooming. You can also change the zoom level or pan the map around using the map control in the top left corner. An example of screen output in the top left corner is shown in FIG. 30. You can also zoom in by double-clicking the map, or zoom out by holding down the control key whilst double-clicking the map. You can pan the map by click-hold and drag, or my using the arrow keys.

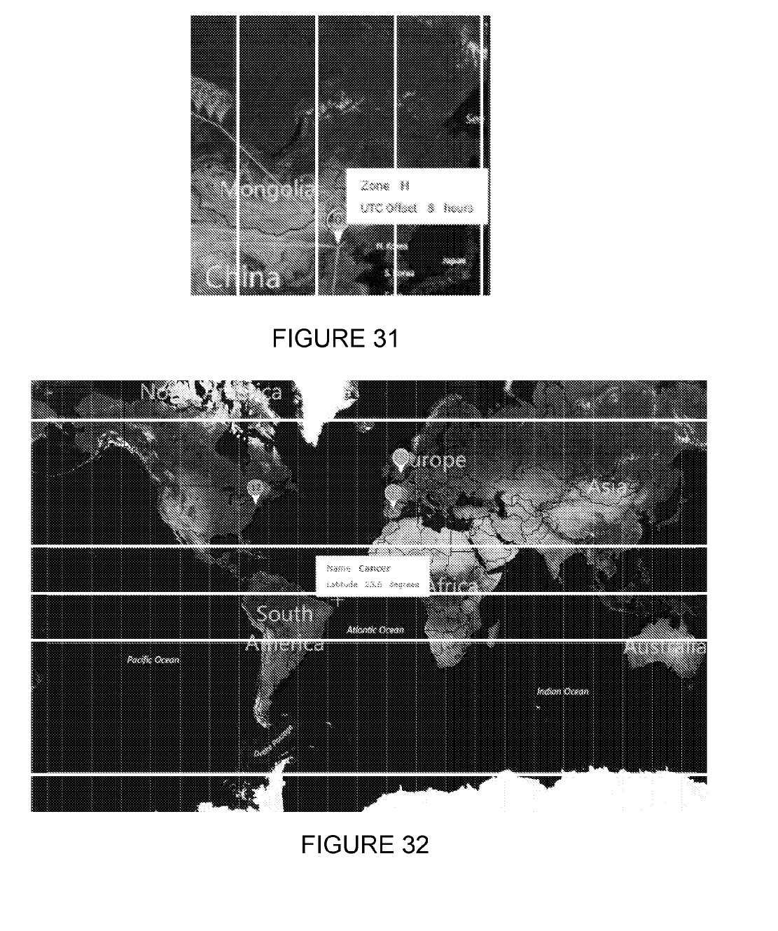

Time Zones. The map has a series of vertical white lines to represent the universal (solar) time zones every 15 degrees of longitude. You can discover the time zone and the UTC offset by moving the mouse cursor near one of these lines. The UTC offset applied to the Signal Time may not provide you the actual time if an asset in a particular location because of regional variations and daylight savings applied locally. An example of part of some screen output containing time zone information is shown in FIG. 31.

Latitude Lines. The major lines of latitude are displayed as horizontal white lines on the map. These are: Artic Circle 66.5 degrees; Tropic of Cancer 23.5 degrees; Equator 0 degrees; Tropic of Capricorn −23.5 degrees, and Antarctic Circle −66.5 degrees. An example of screen output containing lines of latitude information is shown in FIG. 32.

### Assets

Once you have logged in, GeoReach™ WorldViewer will query our secure database over the internet to retrieve the latest signals received from assets in your authorised organisations and groups. The timestamp of this query is displayed on the header as the Last Refresh. By default, this timestamp is displayed as Universal Time Clock (UTC) units, or Greenwich Mean Time (GMT), which is the time zone of all of the data stored in our secure database. You may be using the GeoReach™ WorldViewer client application from a different time zone, so the “Client Time?” checkbox allows you to show the Last Refresh time in your time zone. Note that this alternate time zone display also applies to the Signal Time columns on the Assets and Trails listings. See FIG. 20 for example.

You may have permission to see the assets within multiple organisations, so you can select which organisation you want to observe from the Select an organisation dropdown list. See FIG. 33 for example.

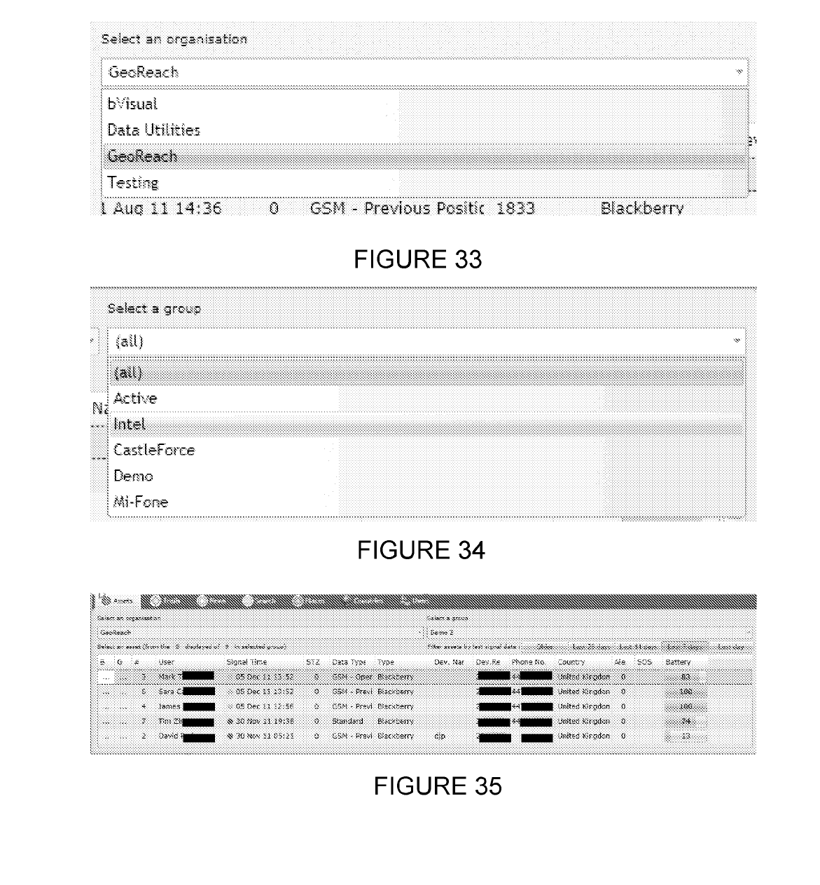

Similarly, you may have permission to view more than one group within your selected organisation, so you can filter your list of assets using the Select a group dropdown list. See FIG. 34 for example.

### Asset Listing Columns

An Assets listing has a number of columns. See FIG. 35 for example. In an Assets listing:
B—Opens Bing Maps in a new browser at the latest position.
G—Opens Google Maps in a new browser at the latest position.
#—Marker display number.
User—The name of the associated User (if any).
Signal Time—The time that the latest signal was sent to our secure database.
STZ—The Solar Time Zone (UTC Offset hours) of the latest position.
Data Type—The method that the latest position was calculated by.
Type—The type of mobile device.
Dev. Name—The name assigned to the mobile device (if any).
Dev. Ref—The built-in reference of the mobile device.
Phone No.—The phone number of the mobile device (if any).
Country—The country that the latest signal position is within.
Alerts—The number of unclosed alerts tagged to the device in a red circle, if there are any.
SOS—A red circle denotes that the last signal was an SOS alert.
Battery—The battery level of the device when the last signal was sent.

### Filtering Assets by Last Signal Date

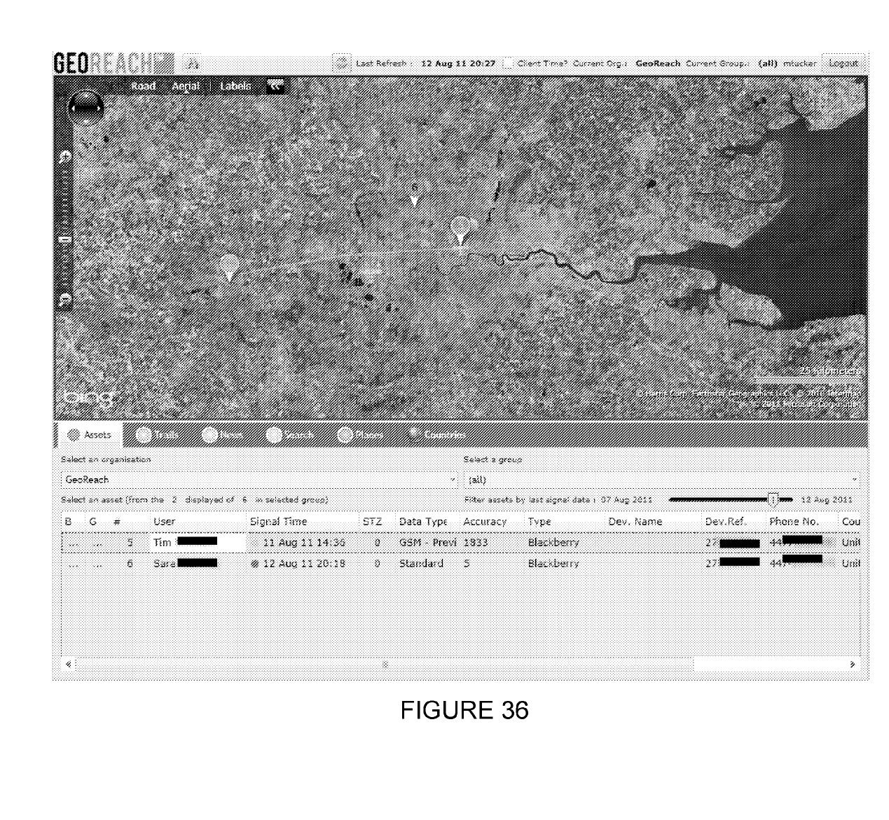

By default, GeoReach™ WorldViewer will display all assets that have sent signals back within three days of the last refresh time, however, you can change this by moving the “Filter assets by last signal date” slider. The listing and the map display markers will be automatically updated as you move the slider. An example is shown in FIG. 36. In FIG. 36, the slider bar extends from 7 Aug. 2011 to 12 Aug. 2011, but the slider is located much closer to 12 Aug. 2011 than to 7 Aug. 2011. Consequently, the users shown in the list only have signal times in 11 Aug. 2011 and 12 Aug. 2011, which are much closer to 12 Aug. 2011 than to 7 Aug. 2011. The user interface reports that only 2 of the selected group of 6 assets are being displayed.

### Trails

The Trails tab lists the positions for the selected asset. You can change the number of days before today that you want to look at the trails for, but be aware that a large number of days may increase the time required for the request to be processed by our servers. To prevent too much data being requested, we limit all queries to return a maximum of 500 rows of data, but we default to just 50 rows initially. Therefore, if a mobile device is sending a position every 4 hours, then 50 rows would be equivalent to just over 8 days worth of data, but if the mobile device is sending a position every 20 minutes, then 50 rows is equivalent to less than 17 hours worth of data.

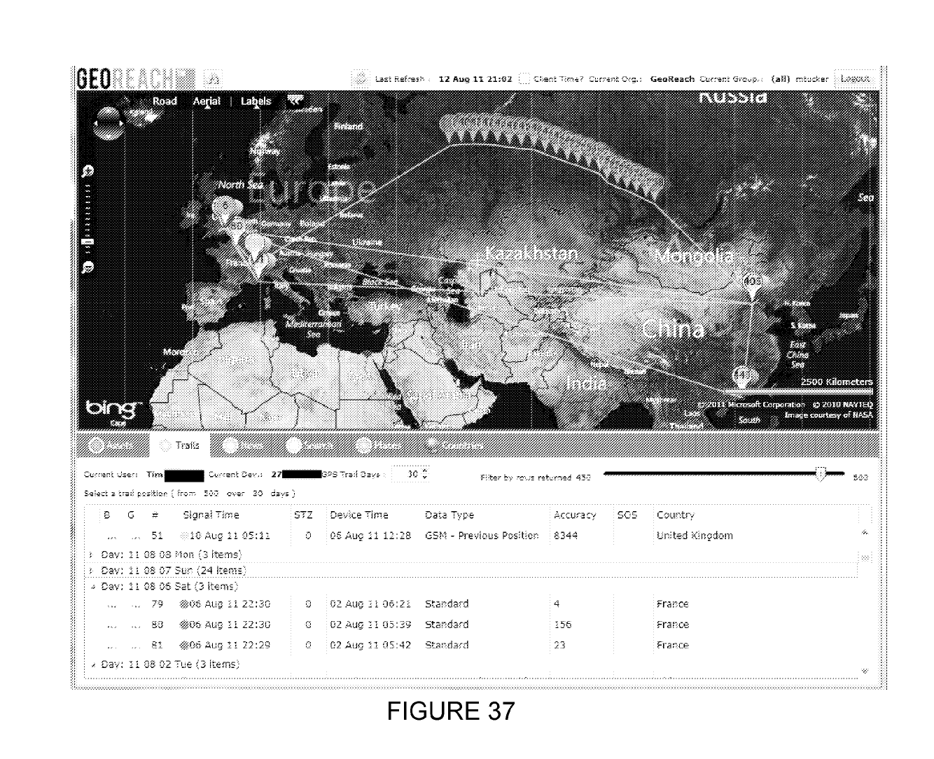

Each of the trail markers is numbered in ascending order from the latest position, and each marker is progressively fainter as they go back in time. The trail markers are also connected via white trail lines to help increase your understanding of their order. An example of trails being displayed is shown in FIG. 37.

### Trails Listing Columns

The Trails listing has a number of columns. These include:
B—Opens Bing Maps in a new browser at the selected position
G—Opens Google Maps in a new browser at the selected position
#—Trail marker number
Signal Time—The time that the signal was received by our secure database
STZ—The Solar Time Zone (UTC Offset hours) of the selected position
Device Time—The time on the device that sent the signal (could be inaccurate because of user error)
Data Type—The method that the latest position was calculated by
Accuracy—The accuracy of the latest position in metres
SOS—A red circle denotes that the selected signal was an SOS alert
Country—Country of the selected signal

### News

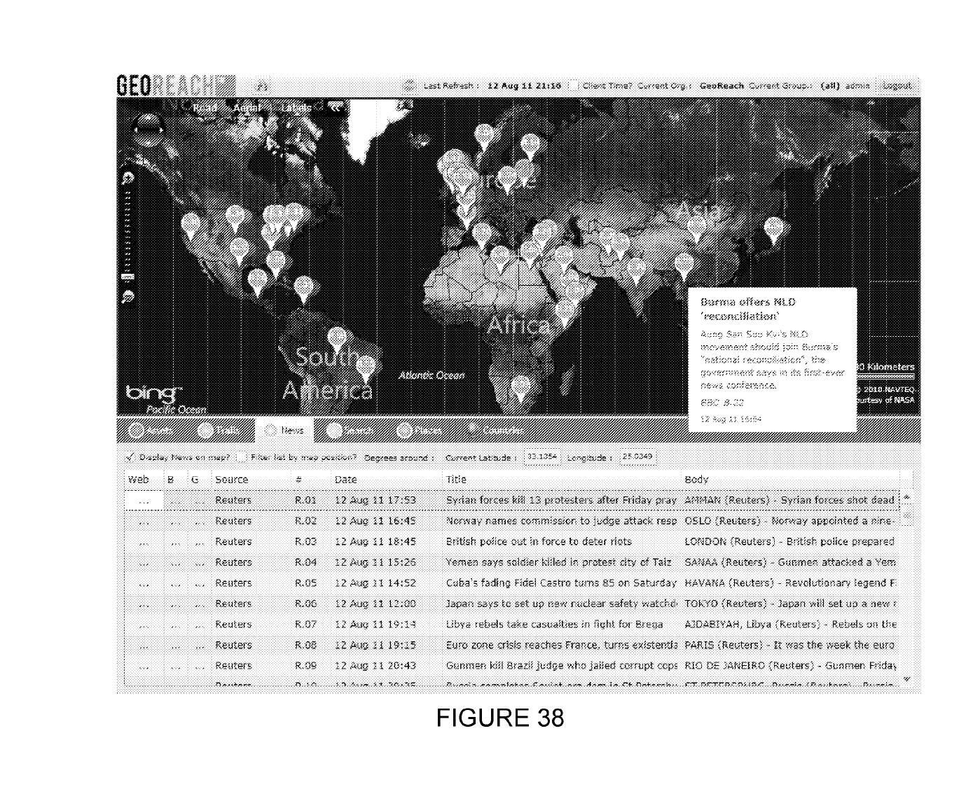

GeoReach™ Light obtains current news stories from a variety of news providers, and then geo-tags them in order to place a marker in the approximate geographic position on the map, as well as listing the stories in a list. An example is shown in FIG. 38.

Note that unless a news story is provided with a latitude and longitude identifier, the geo-tagging service will search the text in the title and body to find matches for known geographic locations. Therefore, it may find the word France and then assume that the story relates to France. The same story could thus be in multiple locations simultaneously because there could be multiple geographic locations matched. In addition, there could be ambiguity because the story may only contain the word Paris, for example, and the geo-tagging service cannot understand if the place is Paris in France, or Paris in Texas. However, the service may select the most probable place. So here, it may select Paris, France, unless the story specifically stated Paris, Tex.

### News Listing Columns

The News listing has a number of columns. These include:
Web—Opens the web page for the news story source
B—Opens Bing Maps in a new browser at the selected position
G—Opens Google Maps in a new browser at the selected position
Source—Source, such as BBC, CNN, Al Jazeera or Reuters
#—Marker number
Date—Story published date
Title—Story title
Body—Story body

### Filtering News by Map Position

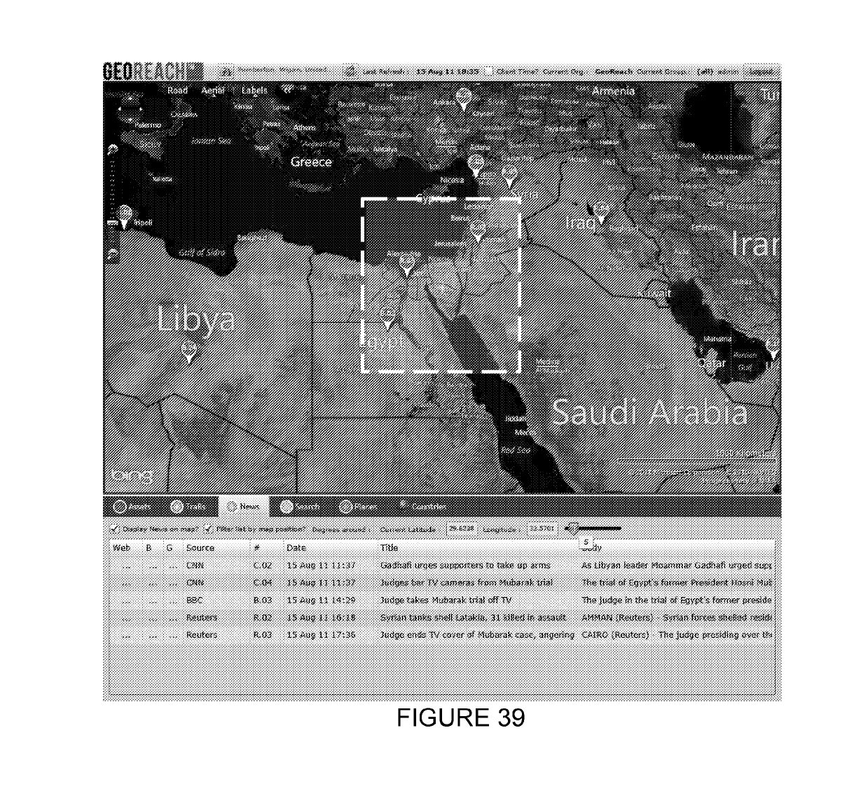

There may be more news stories in a particular location than there appears to be at first. Fortunately, you can elect to filter by your current map position. This will display a translucent or dashed rectangle of a specified number of degrees in size, and the news stories listing will be filtered to list only those that lie within the rectangle. For example, in the screen shot in FIG. 39, you can see that there are six news stories, but there appear to be only three within the rectangle on the map. This is because there are multiple news stories in the same location, so you cannot see all of the markers.

### Search

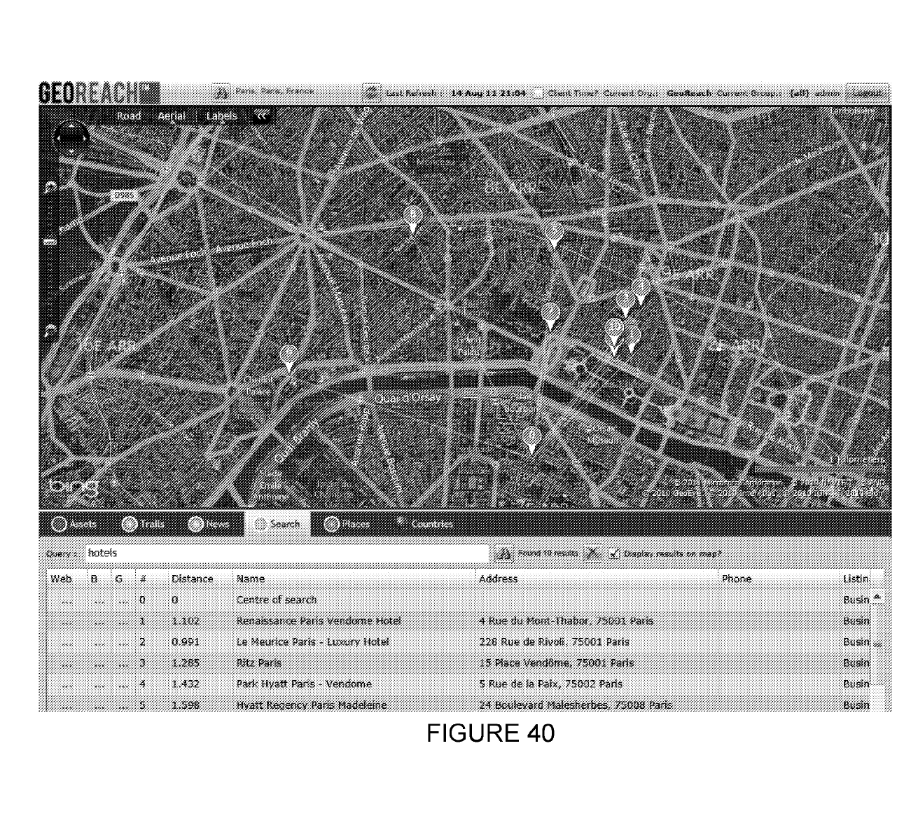

The Search tab allows you to search for a type of location, either within the area in the current map view (as below), or in another location if you add a valid geographic location, such as Hospitals in Munich. If you do not geographically qualify your query string, then you also get a pink line from the centre of your search area. An example of the results of a search for hotels in Paris, France is given in FIG. 40.

### Search Listing Columns

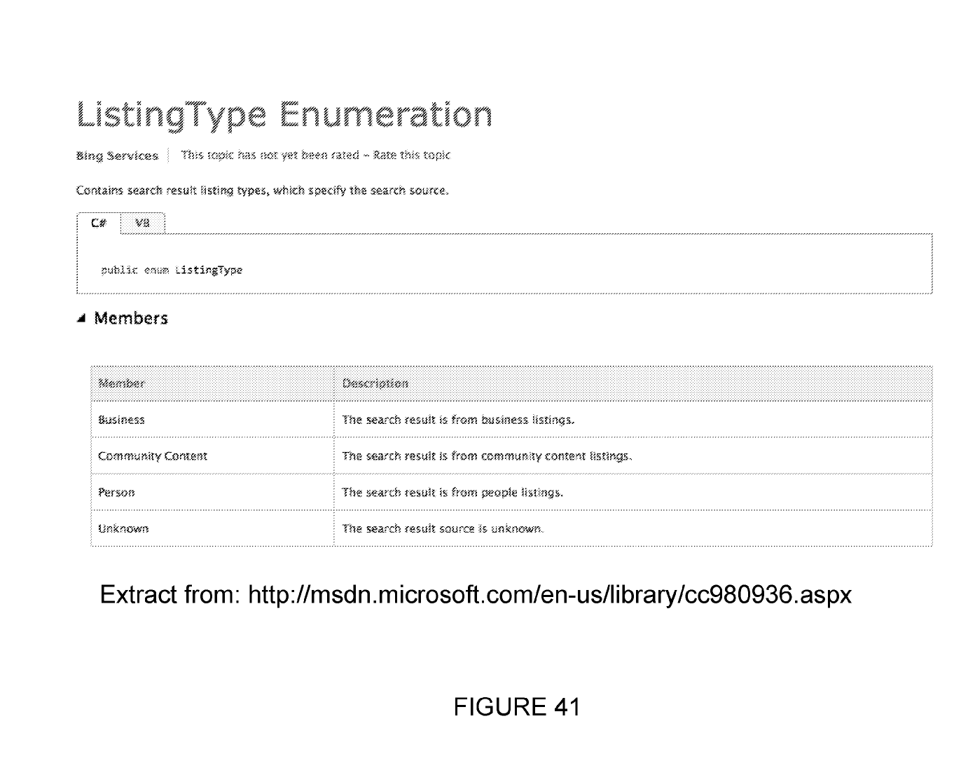

The Search listing has a number of columns. These include:
Web—Opens the web page associated with the search result
B—Opens Bing Maps in a new browser at the selected position
G—Opens Google Maps in a new browser at the selected position
#—Marker number
Distance—Distance in km from the centre of the search
Name-Name
Address—Address
Phone—Phone number
Listing Type—The listing type, see FIG. 41 for example.

### Places

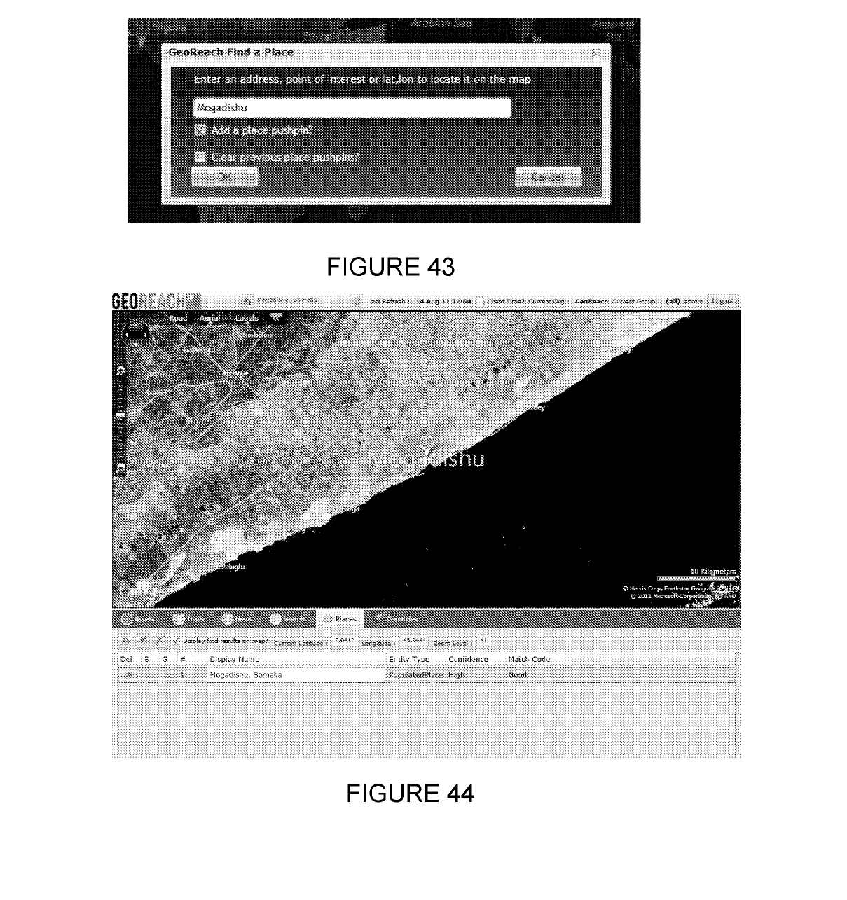

The Find a Place button opens a dialog for you to enter the name of a place to find, or the latitude, longitude co-ordinates. An example is shown in FIG. 43. It is best to enter a “place, country” if you know the country in order to avoid ambiguity. An example of results is shown in FIG. 44.

The first time that you select Find, you may find that some Lat/Lon co-ordinates are already entered. You can add a pushpin/marker for a place, if it succeeds in finding it; or you can elect to clear all previous place pushpins/markers.

### Places Listing Columns

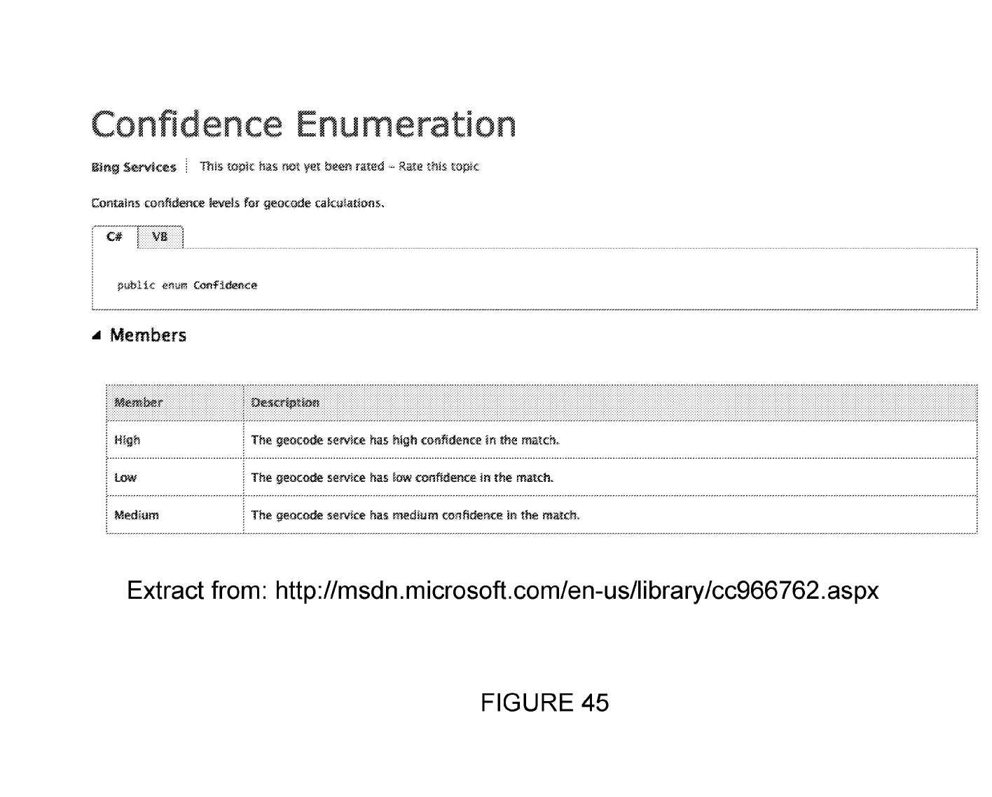

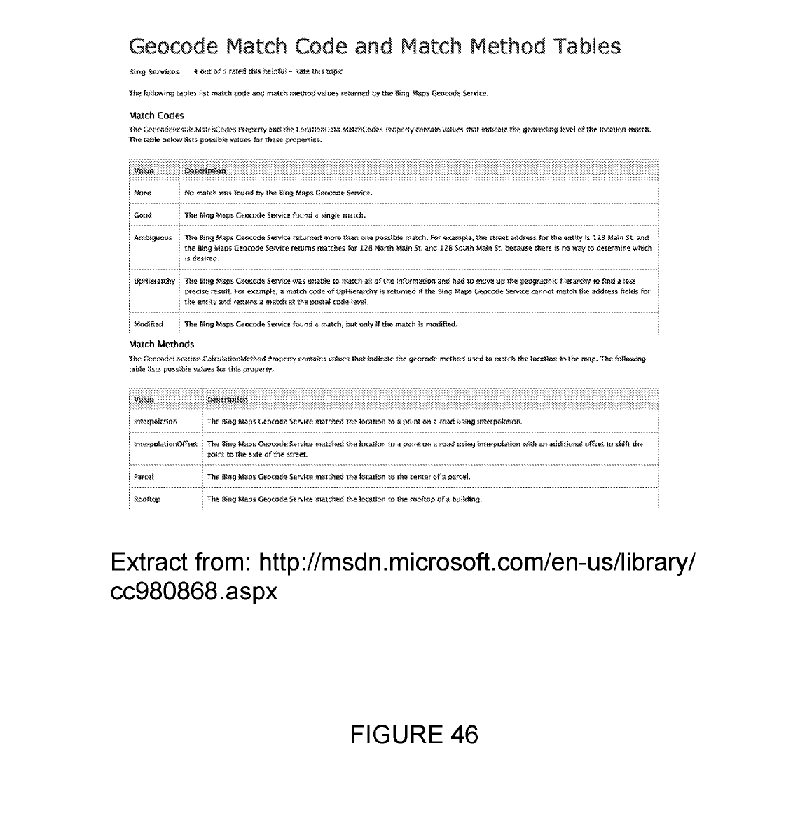

The Places listing has a number of columns. These include:
Del—Deletes the selected place from the listing and map
B—Opens Bing Maps in a new browser at the selected place
G—Opens Google Maps in a new browser at the selected place
#—Marker display number
Display Name—The display name
Entity Type—The classification of the geographic entity returned, such as Address, AdminDivision1, AdminDivision2, AdminDivision3, AdministrativeBuilding, AdministrativeDivision, AgriculturalStructure, Airport etc. For a list of entity types, see for example http://msdn.microsoft.com/en-us/library/ff728811.aspx
Confidence—The level of confidence that the geocoded location result is a match, see FIG. 45 for example.
Match Code—The type of matches used to geocode the locations, see FIG. 46 for example.

### Countries

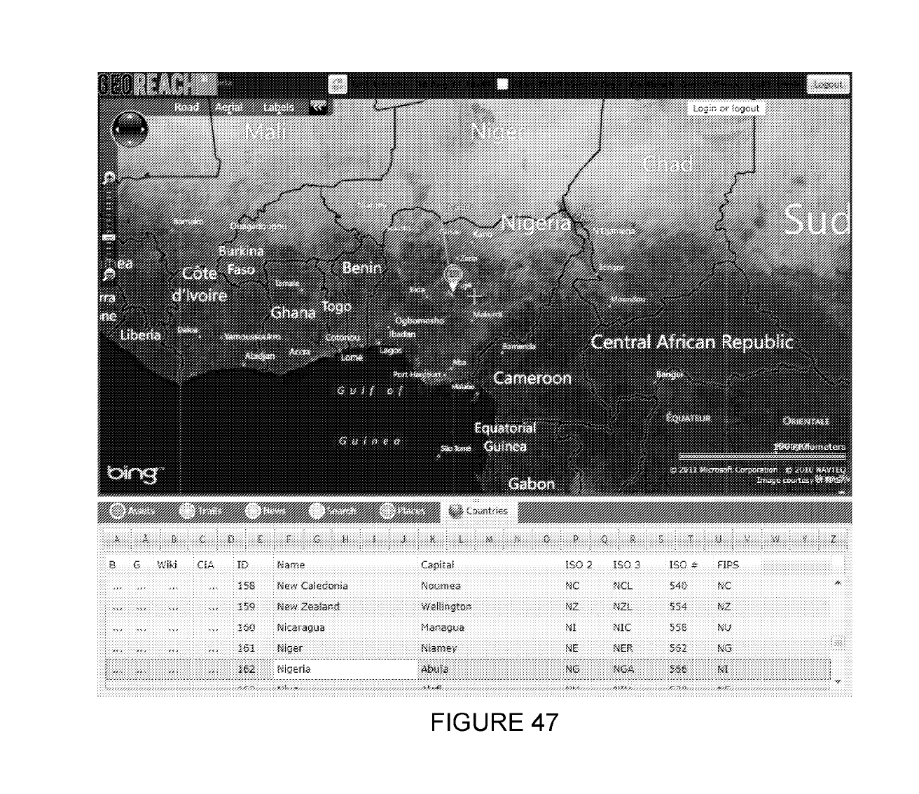

The Countries tab provides a quick and convenient way to pan and zoom the map directly to a country when you select a row, or to open one of the four linked browser pages. You can click one of the letter buttons to scroll to the first country that begins with that letter. An example is shown in FIG. 47.

The Countries listing has a number of columns. These include:
B—Opens Bing Maps in a new browser at the selected country
G—Opens Google Maps in a new browser at the selected country
Wiki—Opens Wikipedia in a new browser at the selected country
CIA—Opens CIA World Factbook in a new browser at the selected country
ID—Unique identifier
Name—Common name in English
Capital—Capital city/town
ISO 2—ISO 2 letter code
ISO 3—ISO 3 letter code
ISO #—ISO number code
FIPS—FIPS 10 code*
   *Codes for the Representation of Names of Countries (ISO 3166) is prepared by the International Organization for Standardization. ISO 3166 includes two- and three-character alphabetic codes and three-digit numeric codes that may be needed for activities involving exchange of data with international organizations that have adopted that standard.
   **Countries, Dependencies, Areas of Special Sovereignty, and Their Principal Administrative Divisions (FIPS 10) is maintained by the Office of Targeting and Transnational Issues, National Geospatial-Intelligence Agency, and published by the National Institute of Standards and Technology (Department of Commerce). FIPS 10 codes are intended for general use throughout the US Government, especially in activities associated with the mission of the Department of State and national defense programs.

### Users

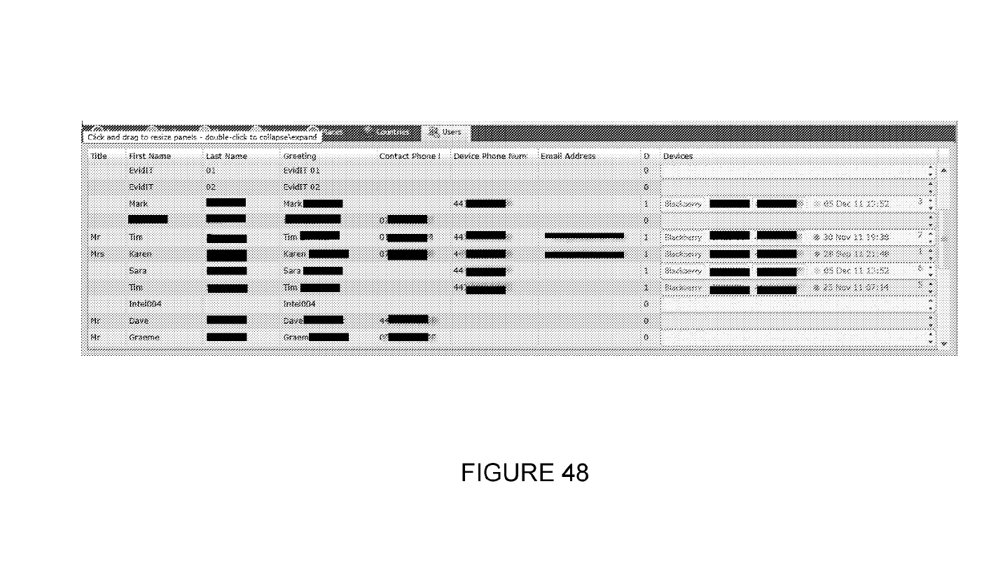

The Users tab allows you to see all of your organisations users, that you have permission to see. This can include their email address, contact and primary device phone numbers, along with a count of devices assigned to them. If the selected device is also in the Assets tab listing, then it will be automatically selected too. An example is shown in FIG. 48.

### Users Listing Columns

The Users listing has a number of columns. These include:
Title—The user's title
First Name—The user's first name
Last Name—The user's last name
Greeting—The user's greeting
Contact Phone Number—The user's contact phone number
Device Phone Number—The user's primary device phone number
Email Address—The user's email address
Dev. Count—Count of devices currently assigned to this user
Devices—Device type, reference, phone number, last signal date time and counter. You can use the up/down arrows to scroll through multiple devices per user.

It will be understood by those skilled in the art that in the above, where columns are used for display, buttons may be provided instead, in which the button is aware of the row that has been selected.

### How GeoReach Tracking Works

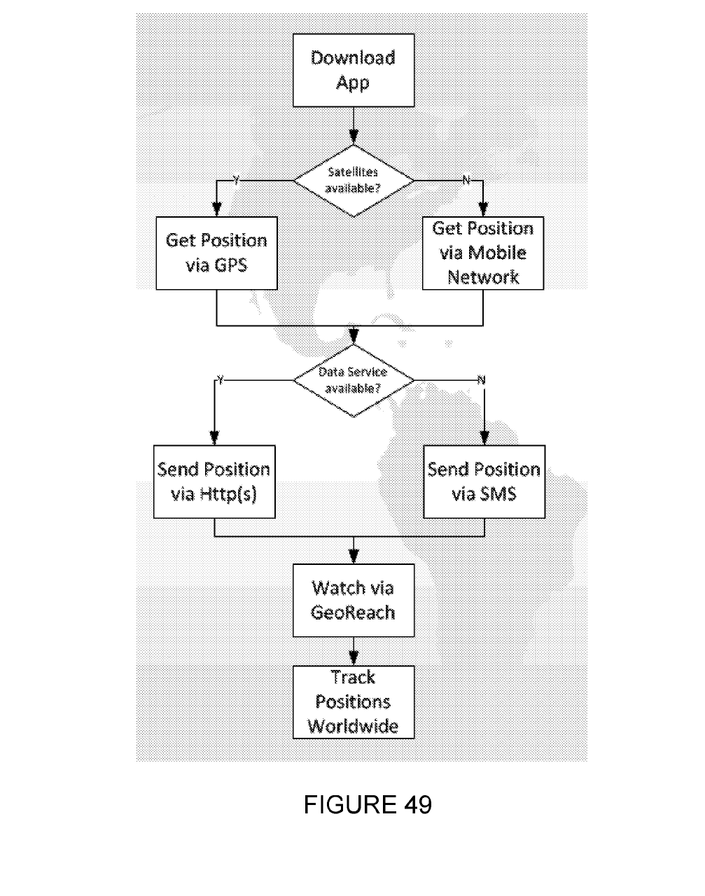

The following outlines how GeoReach™ tracking technology works. The GeoReach™ WorldViewer user does not have to install anything to observe the location of their tracked users. Tracked users, however, may download and install a small application onto their mobile phone, which will send their geographic position back to our database, so that GeoReach™ WorldViewer can observe their locations. An example of the process is shown in FIG. 49.

### Download App

GeoReach™ have created applications for most popular types of mobile phone. You simply need to install the GeoReach™ Tracker application from the web link provided to you for your particular type of phone. In an example, the app is installed on the mobile device by downloading the app from an application server over the internet. Once installed, you simply have to switch on the app and decide the frequency that you wish to send your GPS position to our database.

### Get Position Via GPS

Your mobile phone will attempt to get your position from the Gps signal from as many satellites as it can. The Gps position will be more accurate if more than one satellite can be received, and most accurate if four or more can be received.

### Get Position Via Mobile Network

If there are no Gps satellite signals available (eg. if you are inside a building), then your approximate position will be calculated from the mobile network towers that your signal comes from.

### Send Position Via Http(s)

Once your mobile phone has your position, it will be sent to our database using the internet, if data services are available

### Send Position Via SMS

If your phone does not have data services available, then your position is sent to our servers as a simple text message.

### Watch Via GeoReach WorldViewer

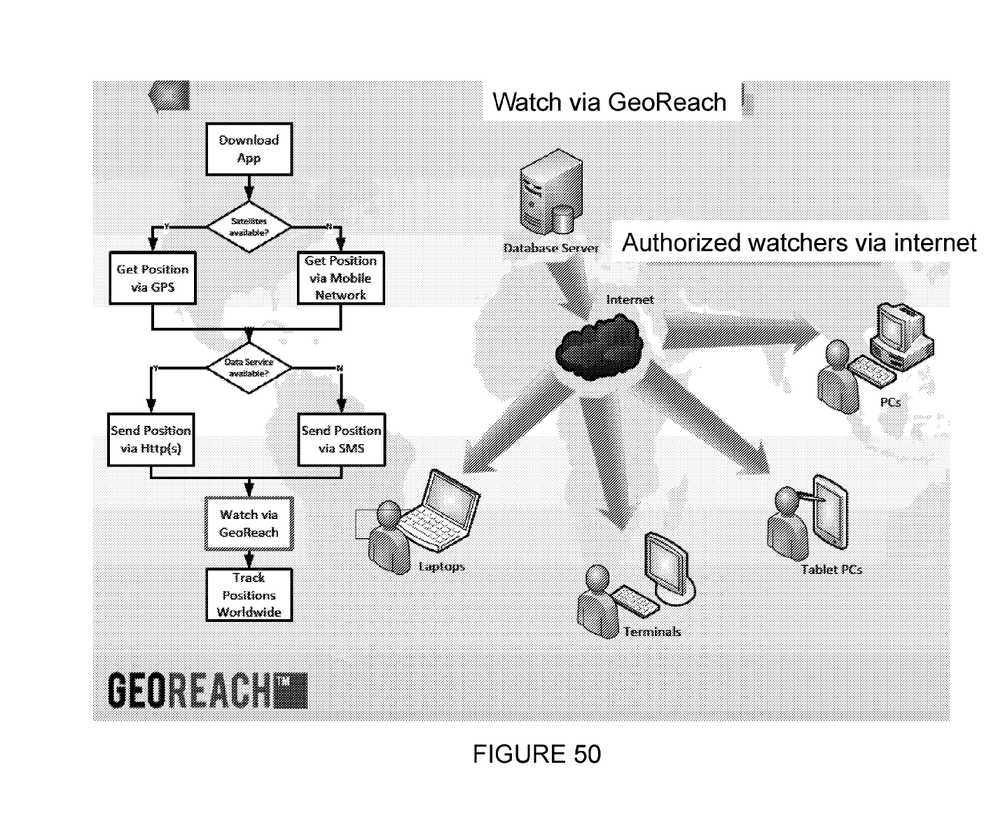

Authorized users of the GeoReach™ web application will then be able to observe your location on a map of the world. An example is shown in FIG. 50.

### Track Positions Worldwide

Authorized users of the GeoReach™ Light application will be able to see any number of tracked users simultaneously, and to see if there are any alerts tagged against them.

### GeoReach Overview

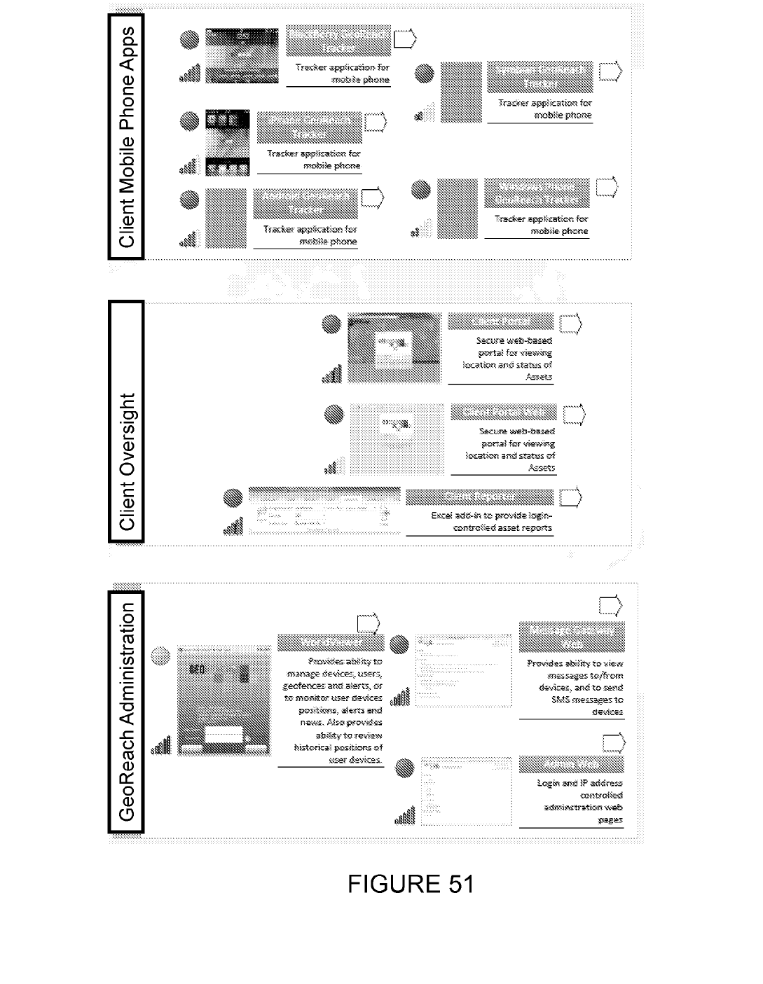

An Overview of an example of the GeoReach system is provided in FIG. 51.

### WorldViewer

Overview: Provides ability to manage devices, users, geofences and alerts, or to monitor user devices positions, alerts and news. Also provides ability to review historical positions of user devices.

Manage: Ability to manage Groups, Devices, Users, Pairing of Users and Devices.

Select: Ability to filter and select User Devices to view either current or historical positions thereof.

User Devices: Ability to view details of User Devices and associated signals, geofences, position trails and device alerts.

Country Risks: Ability to navigate to countries and to open relevant web pages about them. Also provides overview map showing currently monitored user device positions and active alerts.

Alerts: Ability to view/edit alerts. Also provides ability to send an email or an SMS about an alert to someone.

GeoFences: Ability to view/edit point, polyline or boundary geofences, and to optionally assign a risk level and monitoring of ingress or egress by organizations, groups or individual user devices.

Detail Map: Ability to access a detail or Bird's Eye view of any selected location. Also provides ability to launch latest Bing or Google maps.

Media: Ability to view any two news websites simultaneously, in order to monitor breaking news and/or live broadcast.

### Client Portal

Overview: Secure web-based portal for viewing location and status of Assets.

Assets: Ability to filter Assets by organisation and group in order to view last known location and associated details, such as last known battery level and alert status.

News: Ability to view location specific news from selected news sources.

Trails: Ability to review locations of a selected Asset over last number of selected days.

Search: Ability to search for types of buildings in optionally specified location.

Places: Ability to find and navigate to specified locations or lat/lon coordinates. Also has ability to find nearest known location to viewed position.

Countries: Ability to navigate to countries and to open relevant web pages about them.

Users: Ability to view users detailed information, including paired devices.

### Client Portal Web

Overview: Secure web-based portal for viewing location and status of Assets.

Assets: Ability to filter Assets by organisation and group in order to view last known location and associated details, such as last known battery level and alert status.

Trails: Ability to review locations of a selected Asset over last number of selected days.

Countries: Ability to navigate to countries and to open relevant web pages about them.

### Client Reporter

Overview: Excel add-in to provide login-controlled asset reports.

Positions per Day: Bar chart showing daily usage pattern.

Positions per Hour: Clock face chart showing hourly usage pattern.

Battery Usage: Area chart showing daily battery levels.

### Admin Web

Overview: Login and IP address controlled administration web pages.

Ops-Room: Ability to view incoming signals and alerts. Also provides access to alert management, device, user and tracking pages.

Alerts: Ability to view status of any alert. Also provides access to alert management and device detail pages.

Devices: Ability to view/edit devices, send them a command, and to view their latest position of devices. Also provides access to device, organization and tracking pages.

Fences: Ability to view geofences. Also provides access to fence item page, and to open the associated kml files.

Logons: Ability to view/edit/add GeoReach admin and client manager logons.

Organizations: Ability to view/edit/add organizations.

Users: Ability to view/edit/add users. Also provides access to user, organization and device pages.

Traffic Log: Ability to view recent position signals and to show their position on a map. Also provides access to device and tracking pages.

Recent SOS Messages: Ability to view recent SOS messages and to show their position on a map. Also provides access to device and user pages.

Latest Positions: Ability to view recent positions for each device and to show their position on a map. Also provides access to a device page.

Advanced: Ability to access some extra pages.

Device Events: Ability to view latest alerts(events). Also provides access to device and tracker pages.

### Message Gateway Web

Overview: Provides ability to view messages to/from devices, and to send SMS messages to devices.

Devices: Ability to view/edit registered devices and to send commands to them. Also provides access to device, known number, device commands, and version pages.

Inbound Messages: Ability to view inbound messages and to show their location on a map. Also provides access to message, device and cell tower lookup pages.

Outbound Messages: Ability to view outbound messages. Also provides access to message and known number pages.

Send Simple SMS: Ability to send a simple plain text SMS to any mobile number.

Send Application Download-Link: Ability to send a download link direct to a phone number.

General Site: Ability to view web page that provides download links to Operational versions of the mobile device application.

Test versions: Ability to view web page that provides download links to test versions of the mobile device application.

More Advanced Diagnostic Tools: Provides access to more advanced diagnostic pages.

### Message Gateway Web Advanced

More advanced diagnostic tools: Provides access to more advanced diagnostic pages.

Inbound—Summary: Ability to view most recent positions for each device, and to show the position on a map. Also provides access to message, device, known number pages. Versions Summary: Ability to view breakdown of signals received per client application version.

Device and Version—Summary: Ability to view breakdown of signals received per device type and client application version.

Device Signal Statistics: Ability to view breakdown of signals received over time per device.

Device GPS Statistics: Ability to view breakdown of status of GPS for device types, firmware and software versions.

Debug Log: Ability to view raw message text for each message. Also provides access to debug item page.

Devices (Diagnostic Info): Ability to view diagnostic information about each device. Also provides access to device and version pages.

Historical Devices Command: Ability to view commands sent to devices. Also provides access to device command, device, known number, message and inbound message pages.

Known Numbers: Ability to view known phone numbers. Also provides access to known number page.

Simple WAP: Ability to send a WAP message to a phone number.

Voice Message: Ability to send a voice message to a phone number.

Create Simulated Signals—Ability to submit test signals via SMS or web.

Mobile Device App (Eg. For Blackberry, iPhone, Android, Symbian, Windows Phone)

Overview: Tracker application for mobile phone.

Options: Ability to view/edit delivery method, interval and auto-start.

Send Now: Ability to send position immediately back to GeoReach service.

SOS: Ability to start/stop an SOS alert back to GeoReach service.

### Georeach Tracking System Example

### Example of how it Works

The GeoReach tracking system provides a secure oversight of the worldwide location of tracked devices. The GeoReach tracking application can be installed onto most mobile phones to send back the position of the device to a centralised database. The position can be extremely accurate if the device has GPS capability, and satellite signals are available, or they can be approximated by using the connected mobile cell tower position.

The communication between the devices and the GeoReach servers are via SMS, https or http, and those between the GeoReach server and the Client Manager Oversight or GeoReach Administration is via https. FIG. 21 shows a schematic diagram of an example of a monitoring system.

### Message Gateway Overview

The GeoReach tracker application on the mobile phones obtains a GPS location if the device is GPS enabled, and it can receive signals from any GPS satellite. The GeoReach tracker application can be set to send these position signals, or just the currently connected mobile network cell tower identifier, to the GeoReach tracking system periodically. The mobile phone user can modify the delivery period, and GeoReach may use Aql, (see http://aql.com—a company based in Leeds, UK), to host an SMS gateway that can send and receive SMS messages to mobile phone handsets. GeoReach have setup the Messages database to store the data that goes to and from the external gateway.

### GeoReach Databases Overview

The GeoReach databases comprise of three separate databases on the same Microsoft SQL Server 2008 database on a Windows 2008 server. The Messages database interfaces with the external SMS Gateway via the internet. The Messages database interface directly with the Tracking and Cell Towers databases.

### Messages Database

The Messages database is used for data that is received from the external Message Gateway, or is to be sent to it. The Messages database does not attempt to interpret any positional information, but does attempt to identify the sending/receiving device by reference and/or MSISDN. The Messages database passes signal data to the Tracking database, which parses the messages into the tracking data tables.

### Tracking Database

This is the main database in the GeoReach Tracking System, and receives message data from the Message database and parses it into a defined schema. The primary areas of the Tracking database are:

Security. All access to the database is controlled via a login. Client logins using a user name/password combination are converted to a login token for each session.

Organisation. The database can be split into multiple Resellers. Each reseller can have multiple organisations; and each organisation can have multiple organisation groups. A user belongs to an organisation.

Devices. A device is owned by an organisation, but can be assigned to multiple organisation groups. A device can be paired with a user for a period of time.

Position Data. The position messages that are parsed from the Message database into the TrackingData table are linked to a device. Aged position data can be removed from the database in accordance with the agreement of any client company.

Geography. In addition to countries of the world, (geo-)fences are stored with any number of (geo-)fence items. (Geo-)fences are owned by a reseller and organisation, and can be linked to any number of organisation device groups or devices.

Alerts. Alerts are created by a trigger action, and are then linked to a device, and optionally to a fence. Alert log items are created to maintain a history of how an alert was opened, or who changed its status, and when.

### Cell Towers Database

This database stores information about mobile network cell towers. Each telecom network provider identifies cell towers by Country (MCC), Network (MNC), Area (LAC) and CellID.

When the GeoReach system receives a GPS position along with a cell tower identifier, then it stores this within the Cell Towers database. When more GPS signals are received from the same cell identifier, then this is added to the known positions for the cell identifier. If a signal is received from a device without a GPS position (because the device is underground or in a building, for example), then the GeoReach system checks the Cell Towers database to see if the cell identifier is already known. If it is, then the position is shown to be the centre of the previously known gps positions, with the accuracy stated to be the radius of the circle that would cover the previously known gps positions.

There are several publicly available cell tower network databases that provide many thousands of cell towers (for example OpenBMap and OpenCellID), which are imported periodically into the GeoReach Cell Towers database. There are also larger commercially available databases, such as Location-API, that can be used for a price, but the data can only be used for a set period of time. GeoReach Cell Towers database currently has the facility to use Location-API data. The database may include WiFi hotspots, stored in a similar manner to the cell identifiers described above.

### Admin Web

Overview: Login and IP address controlled administration web pages. This web site is used internally within the client response centre (CRC) only, and provides administrative access to review and edit the main data features.

### Ops-Room

Ability to view incoming signals and alerts. Also provides access to alert management, device, user and tracking pages. This web page provides additional overview of the basic state of the system, allowing an administrator to navigate to relevant detail, and to verify that the system data is flowing.

### Alerts

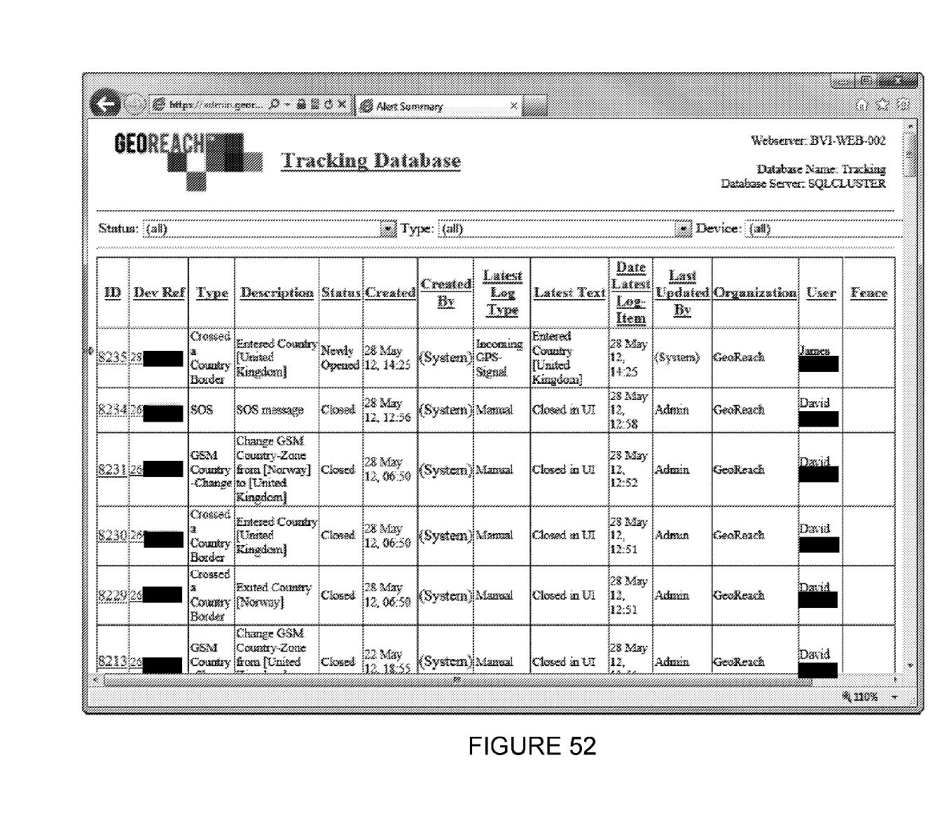

Ability to view status of any alert. Also provides access to alert management and device detail pages. This web page shows when, and how, an alert was first raised, and what its current status is, along with the device that the alert is linked to. This web page may include the editing of automated actions as a result of an alert, such as emails sent, phone calls made, or SMS messages sent, or just who was notified. An example Alerts page from a Tracking Database is shown in FIG. 52.

### Devices

Ability to view/edit devices, send them a command, and to view their latest position of devices. Also provides access to device, organization and tracking pages. This web page displays a quick summary of the known status, and any internal comments, of each device. This enables the administrator to review and edit the information of the physical hardware devices, and to track the MSISDN (SIM-card) expected in each device.

### Fences

Ability to view geo-fences. Also provides access to fence item page, and to open the associated kml files. This web page displays (geo-)fence collections, and enables their properties to be edited, which can affect the alert actions that are triggered. (Keyhole Markup Language (KML) is an XML notation for expressing geographic annotation and visualization within Internet-based, two-dimensional maps and three-dimensional Earth browsers. Extensible Markup Language (XML) is a markup language that defines a set of rules for encoding documents in a format that is both human-readable and machine-readable.)

### Logons

Ability to view/edit/add GeoReach admin and client manager logons. The administrator can edit the logon names, contact details, along with a list of permissions for which features, organisations and devices that each logon has access to.

### Organizations

Ability to view/edit/add organizations.

### Users

Ability to view/edit/add users. Also provides access to user, organization and device pages. The user information can be added or edited from this web page, along with the paired device(s) that a user may have.

### Traffic Log

Ability to view recent position signals and to show their position on a map. Also provides access to device and tracking pages. This web page provides an additional diagnostic tool to verify the important tracking data is correctly linked to locations, and the method of arrival (via SMS or http(s)).

### Recent SOS Messages

Ability to view recent SOS messages and to show their position on a map. Also provides access to device and user pages. This web page provides the ability to verify source of any recent SOS messages, and to check its accuracy by comparing the mobile network country with the location country, for example.

### Latest Positions

Ability to view recent positions for each device and to show their position on a map. Also provides access to device page.

### Advanced

Ability to access some extra pages. The Advanced option is intended for technical support technician rather than the CRC-operator.

### Device Events

Ability to view latest alerts (events). Also provides access to device and tracker pages. This page displays how various events are logged, and the alert raised, if appropriate. Actions that can cause an alert include:
Device enters a monitored geo-fence
Device leaves a monitored geo-fence
Device re-appears (after having been idle for a long-time)
Device enters/leaves a “known country border” (according to latitude/longitude position)
Device enters/leaves a “GSM network-zone” (even if no latitude/longitude yet available)

All these items are logged (even through some of them are just “informational” rather than “significant event-raising items”).

### SMS

Ability to open the Message Gateway website.

### Message Gateway Web Overview

Provides ability to view messages to/from devices, and to send SMS messages to devices. These web pages interface with the Message database directly, in order to view or edit SMS-content.

Inbound Summary—Ability to view most recent positions for each device, and to show the position on a map. Also provides access to message, device, known number pages.

Devices—Ability to view/edit registered devices and to send commands to them. Also provides access to device, known number, device commands, and version pages.

Inbound Messages—Ability to view inbound messages and to show their location on a map. Also provides access to message, device and cell tower lookup pages. This web page provides a diagnostic tool to view the detail of individual incoming messages, and provides a full audit-trail of any communication from each device.

Outbound Messages—Ability to view outbound messages. Also provides access to message and known number pages. This web page displays both the device commands and other messages transmitted from the system, and provides a full audit-trail of any communication to each device.

Send Simple SMS—Ability to send a simple plain text SMS to any mobile number. This tool can provide a diagnostic tool to send and test SMS messages through the system.

Send Application Download Link—Ability to view web page that provides download links to Operational versions of the mobile device application.

General Site—Ability to view web page that provides download links to test versions of the mobile device application.

Test Versions—Ability to view web page that provides download links to test versions of the mobile device application.

More Advanced Diagnostic Tools—Provides access to more advanced diagnostic pages. A number of the links on this web page are useful for analysing the efficiency of particular device hardware and application versions.

Versions Summary—Ability to view breakdown of signals received per client application version.

Device and Version—Summary—Ability to view breakdown of signals received per device type and client application version.

Device Signal Statistics—Ability to view breakdown of signals received over time per device.

Device GPS Statistics—Ability to view breakdown of status of GPS for device types, firmware and software versions.

Debug Log—Ability to view raw message text for each message. Also provides access to debug item page.

Devices (Diagnostic Info)—Ability to view diagnostic information about each device. Also provides access to device and version pages.

Historical Devices Command—Ability to view commands sent to devices. Also provides access to device command, device, known number, message and inbound message pages.

Known Numbers—Ability to view known phone numbers. Also provides access to known number page.

Simple WAP—Ability to send a WAP message to a phone number.

Voice Messages—Ability to send a voice message to a phone number. This web page provides the ability to convert text to voice, so that a message could be left for an emergency contact, for example.

### Create Simulated Signals—for a Given Version

Ability to submit test signals in a given version format via SMS or web. This a useful diagnostic tool verifies that certain parts of the system are working, and can be used to simulate gps trails.

### Client Mobile Phone Apps

Applications have been developed, for Blackberry OS; Apple iPhone/iPad iOS; Google Android OS; Nokia Symbian; and Microsoft Windows Phone 7+. Some of the features listed below are dependent upon the capabilities of the hardware and/or operating system. A set of text instructions have been developed by GeoReach that enables most features on the device to be activated via an SMS sent from the GeoReach server.

Overview—Tracker application for mobile phone.

Options—Ability to view/edit delivery method, interval and auto-start. The user can set a primary and an optional secondary delivery method; each of which can be SMS, https or http. The delivery interval can be set at various periods from 1 to 120 minutes.

Send Now—Ability to send position immediately back to GeoReach service.

SOS—Ability to start/stop an SOS alert back to GeoReach service. Once an SOS is started by a user, then the position signal will be sent every minute until the SOS is closed on the device, or the battery runs down.

Auto Start—This feature automatically re-starts the GeoReach tracker application after the device is switched off and on again, or after a low-battery causes all communication to be stopped.

Locate Colleagues—In an example, it is possible to include a map in the device so that the user can view their own location, and those of nearby colleagues.

Localised News—In an example, it is possible to include a feed of relevant news events local to the device user, either directly from a public georss feed, or from the GeoReach system.

Notify Event—In an example, it is possible for a user who witnesses an event to be able to notify the GeoReach system so that nearby colleagues can be informed.

Evidence Cloud—In an example, it is possible to include send photographs and/or sound recordings back to the GeoReach system. This is optionally enabled whenever an SOS is triggered.

Device registration—In an example, it is possible to register a device in the GeoReach system from the device handset.

### WorldViewer

Overview: Provides ability to manage devices, users, geofences and alerts, or to monitor user devices positions, alerts and news. Also provides ability to review historical positions of user devices.

User Name: The user name should be one that exists in the GeoReach Tracking Database. User names are created or deleted using the Admin Web/Logons page. A User name does not need to be associated with any tracked mobile device, but an email and/or contact phone number is recommended.

Password: The password is created using the Edit button on the Admin Web/Logons page. It can either be randomly created or entered manually, and can be emailed directly to the user.

User Token: The user name/password combination is used to logon to the GeoReach Tracking Database using a web service. The web service returns a user token that is used to submit any subsequent queries or updates to the database via the web service.

Associated Permissions: By default, a user name cannot view or edit any database information, but it can be associated with view or edit permission on organisations, device groups, user groups, devices or users.

Manage: Ability to manage Groups, Devices, Users, Pairing of Users and Devices.

Organisation: The GeoReach Tracking Database can store multiple uniquely named organisations, with the default being GeoReach itself.

Group: Each organisation can be split up into multiple uniquely named groups. Devices, users or geo-fences can be associated with zero, one or more groups.

Users: Each organisation can have zero, one or more users, which can be added with the Add User Info button, or via the View Users button. A user can be paired with zero, one or more devices via the Open Devices button on the Device tab.

Status: Each device can be assigned a status, with the default being New registration. The Status can then be edited to Active or Inactive, for example, as required. The Status pull-down list provides the ability to filter the list if user devices by status.

User Devices: The list of user devices displays some of the attributes of each user and device, and allows for a selected user or device to be viewed or edited via the tabbed panels to the right.

Device: This tab displays device info and provides a button to edit its details and its pairing with users.

Geofences: This tab may be provided. After selecting this tab a user may define, view, or edit a point, a polyline or a boundary geo-fence, and optionally assign a risk level and monitoring of ingress or egress by organizations, groups or individual user devices. After selecting this tab a user may list the devices last reported to be within the selected geofence, and to compose an email, SMS or notification to be delivered to selected devices. After selecting this tab a user may generate a geofence from a previously selected news item.

User Info: This tab displays the paired user information and provides a button to edit these details along with an address and emergency contact details.

Owner and Groups: This tab enables a device to be added or deleted from groups in the organisation.

Last Location: This tab displays detail about the last known location of the device.

Last Signal: This tab displays detail about the last known signal from the device.

GPS Data Summary: This tab displays a summary of signals received from the device, so that a comparison of gps versus non-gps signals can be identified. This feature is expanded in the Client Reporter add-in for Excel.

Select: Ability to filter and select User Devices to view either current or historical positions.

Organisation and Monitor Alerts: The drop-down list provides the ability to filter the list of user devices by organisation. In addition, this selected organisation is used for monitoring alerts if the Options/Monitor Alerts option is ticked. If an alert is triggered by a user device in the selected organisation, then the user device will be automatically added to the current list of selected user devices.

Group: The drop-down list provides the ability to filter the list of user devices by group. Status: The drop-down list provides the ability to filter the list of user devices by device status.

Date/Time Selectors and GPS Trails: The default selected To Date is the current date/time, and the default time period for known positions (trails) is the last known position only. However, the operator can select to view from any date to any date, and can use the drop down list to automatically set the From Date as a calculation from the To Date minus one hour, 24 hours, 7 days or 28 days. Alternatively, the operator can enter or select dates and times manually. The default query to the database via the web service is to return a summary of GPS trails, meaning that identical positions over a time period will be reduced to first and last times at that position. There is also an option to return a list of all received position signals. If the operator wishes to view the trails on the map, then Options/View Trails option may also be ticked.

Close, Replace and Add: The operator can choose to add selected user devices to the list of monitored user devices, or to replace the list with a new list.

User Devices: Ability to view details of User Devices and associated signals, geo-fences, position trails and device alerts.

Listing: The listing displays the most useful details about each device, and its currently paired user. The operator can quickly identify if there are any unclosed alerts, the last known battery level, last known location. The tool-strip on the left-hand side enables tasks related to the selected user device to be performed.

Toolstrip Buttons: The tabs on the right-hand side allow the user device position to be added to the map (along with any trails, if that Option has been ticked). The colour of the device circle and text can be edited manually. There are buttons to open the Time Zone Converter web page, and Bing or Google Maps. The device position, and any selected trails, can be exported into a kml file, which could, for example, be opened up in which ever application the operator has registered for opening kml files, such as Google Maps.

Last Signal Tab: This tab displays detail about the last signal received from the device.

Fences Tab: This tab displays a list of monitored geo-fences that are associated with the selected device. This could be because the geo-fence has been linked to the device individually, or because the device is part of a group that has been linked to the geo-fence; or the device is part of an organisation that has been linked to a geo-fence. Finally, a geo-fence could have been linked to the whole GeoReach tracker database. The tab also has buttons to display the geo-fence on the map; to raise or close alerts for the selected fence; or to export the geo-fence as a kml file.

GPS Trails Tab: This tab lists all of the stored positions for the selected device over the time period specified in the Select panel. In addition, the operator can refine the time-slice of displayed positions with a dual-slider control. Each position can be selected and opened in Bing or Google maps.

Device Alerts Tab: This tab displays the open alerts (and closed alerts within the last hour) of the selected device. It also enables the operator to close an alert, or to raise a test alert.

Alerts: Ability to view/edit alerts. Also provides ability to send an email or an SMS about an alert to someone.

Listing: This listing displays the alert type, status and the device that it is associated with. Toolstrip Buttons: These buttons enable the selected alert to be closed, or for a summary of it to be sent to a specified SMS number or an email address.

Detail Tab: This tab displays the details of the selected alert.

Log Items Tab: This tab displays a log of actions taken for the selected alert. The operator can add a log item.

Countries: the ability to list the devices last reported to be within the selected country, and to compose an email, SMS or notification to be delivered to selected devices.

Alerts tab: Listing of all open alerts for the selected organisation.

### Geofences

Ability to view/edit point, polyline or boundary geo-fences, and to optionally assign a risk level and monitoring of ingress or egress by organizations, groups or individual user devices. The ability is provided to list the devices last reported to be within the selected geofence, and to compose an email, SMS or notification to be delivered to selected devices.

GeoReach tracking database can store geo-fences (sometimes referred to as placemarks), which can be associated with organisations, groups or individuals. These geo-fences can have an assigned risk level, name, description, country and a web page for more information. The operator can create geo-fences as points, with a radius of tolerance; or multi-segmented lines, with an offset tolerance; or as a boundary.

The geo-fences are stored as a named collection of geo-fences in the GeoReach tracking database. Each geo-fence has an associated kml (Keyhole Markup Language) file, along with extra details, such as name, description and country.

Each geo-fence can be assigned a temporal domain, in as much as it can have a start and end date set for when it is operational. This is useful for events or itineraries.

Each geo-fence collection can be created, and saved on the operators local file system as a library, and can be saved to the GeoReach tracking database as either a monitored or unmonitored item, with an assigned fence type (Itinerary, Incident, PointsOfInterest, or RiskArea), and a fence category (such as Airports, Embassies, Hospitals, etc).

Each geo-fence collection can be linked to all GeoReach database devices, to the current organisation, selected groups, or to selected devices.

Listing: This listing displays details of each geo-fence collection, such as it's name, type, category, count of items in the collection, and a count of the organistations, groups and devices that it is associated with.

Toolstrip Buttons: There are buttons to create and delete geo-fence collections, or to export the selected geo-fence collection as a kml file. The local library collections has a button to save a selected one to the GeoReach tracker database. The GeoReach tracker database geo-fence collections have buttons to raise and close alerts for them. This means that all devices, and therefore the paired users, who are within a geo-fence can be quickly alerted to any dangers that may occur.

Items tab: This tab enables individual points, multi-segmented lines, and boundaries o be deleted or created.

Alerts tab: This tab displays any alerts that are open against the selected geo-fence, and has a button to raise an alert too.

Country Risks: Ability to navigate to countries and to open relevant web pages about them. Also provides overview map showing currently monitored user device positions and active alerts.

Listing: The listing displays the assessed risk level of each country, along with all of the international identifiers for each country. The toolbar provides filtered access to a number of web-sites for maps, information and news about each country.

Inset Map: This map can display the countries of the world in normal grey shade, coloured by risk level, or by continent. In addition, it displays all of the monitored user devices at their last known positions. Any user device that has an unclosed SOS alert will flash bright red, in addition to an audible beeping sound. The operator can select countries from the listing or by moving the mouse over the map.

Media: Ability to view any two news websites simultaneously, in order to monitor breaking news and/or live broadcast. The operator can specify which two web pages to have open by default in the WorldViewer.config file in the installation folder. A user may generate a geofence from a selected news item.

Detail Map: Ability to access a detail or Bird's Eye view of any selected location. Also provides ability to launch latest Bing or Google maps.

Toolbar buttons: In addition to be able to open Bing or Google Maps at the centred position, there are buttons to pan and zoom to the location at the centre of the main map. This panel is provided to allow the Bird's Eye view in the newer Bing Maps AJAX control to be viewed, because the earlier Microsoft Virtual Earth AJAX control used in the main map area does not have this capability. The capabilities of the latest Microsoft Bing Map AJAX control may be utilised in the Client Web Portal.

### Client Portal

### Overview

Secure web-based portal for viewing location and status of Assets.

The client portal utilises a secure Windows Communication Foundation (WCF) service from the GeoReach tracking database. The initial version of the client portal is written using the Silverlight version of Microsoft's Bing Maps control, a version using the Microsoft AJAX Bing Maps control is also possible. Although Microsoft's Bing Maps is used for the main presentation of the data, easy access is provided to Google Maps as an alternative within the application.

User Name: The user name should be one that exists in the GeoReach Tracking Database. User names are created or deleted using the Admin Web/Logons page. A User name does not need to be associated with any tracked mobile device, but an email and/or contact phone number is recommended.

Password: The password is created using the Edit button on the Admin Web/Logons page. It may be randomly created or entered manually, and can be emailed directly to the user.

User Token: The user name/password combination is used to logo to the GeoReach tracking database using a web service. The web service returns a user token that is used to submit any subsequent queries or updates to the database via the web service.

Associated Permissions: By default, a user name cannot view or edit any database information, but it can be associated with view or edit permission on organisations, device groups, user groups, devices or users.

Signal Times: Position signals are sent from devices into the GeoReach tracking database from all over the world. The date time on any device is editable by the user, and may or may not be correct. Therefore, it is better to have all times stored in a consistent time zone. The GeoReach tracking database stores date/times in Greenwich Mean Time (GMT), alternatively known as Coordinated Universal Time (UTC). The default presentation of the Asset and Trail Signal Time is UTC, but the operator can tick the “Client Time?” checkbox to display the Signal Time in the same time zone as the pc or laptop that the operator is viewing the client portal on. The Signal Time column in Asset and Trails tabs displays a yellow circle if the time of day of the position signal is during daylight, or else it displays a black circle to signify that the signal was during night time. The calculation is made from the latitude, longitude and time of the position signal, which is then checked against the calculated sunrise and sunset times at that location. The STZ (Solar Time Zone) column displays the number of hours that the position is offset from UTC. Note that the political time zone set by governments, which may also have daylight saving offsets at certain times of the year, can be different to the solar time zone, which can be calculated from the longitude of the position.

Bing and Google Maps: Most of the listings have columns headed as B for Bing Maps and G for Google Maps. These columns provide a hyperlink button to open the position in either Bing or Google maps in a new web browser window. This is provided because some areas are best covered by Bing Maps, and some areas are covered best by Google Maps. In addition, Bing Maps has a Bird's Eye view that can be rotated, whereas Google Maps has Street View.

Assets: Ability to filter Assets by organisation and group in order to view last known location and associated details, such as last known battery level and alert status. The term Asset may be used in the client portal as an alternative to the term User Device in WorldViewer. An Asset or User Device is a mobile phone with the GeoReach tracking application installed, or a third-party gps device that sends position signals to the GeoReach tracking database. In either case, the device may or may not be paired with an actual user.

Filter assets by organisation and group: The operator can filter the list of assets displayed in both the assets listing and the map by selecting an organisation and group from the respective drop-down lists. The operator can only select an organisation and group that they have been given permission to view.

Filter assets by last signal date: The operator can filter the list of assets displayed in both the assets listing and the map by selecting a period of time that the last signal has been received in. The default is to display all assets that have sent a position signal within the last seven days, but the operator can alternatively choose to view assets that have sent with the last day, last 14 days, last 28 days or even older. Note that asset positions may have been deleted from the database upon the request of the client organisation.

Asset listing: A unique number is assigned to each row in the assets listing, and this number is also displayed in the centre of the associated magenta icon at the last signal position on the map. One of the columns in the listing displays the Signal Time that includes a day/night time circle that is encircled in red if there are any unclosed alerts associated with the asset. The corresponding magenta asset icon on the map is shaded either yellow or black to represent day or night time, and is also encircled in red if there are unclosed alerts.
The User column displays the first and last name of the paired user, if there is one. This User is also displayed in the tooltip of the map asset icon.
The Dev. Name column displays optional name given to the device. This is useful if a user is paired with multiple devices, or the device does not have a paired user.
The Dev.Ref. column is the unique identity of the device in the GeoReach tracking database. In the case of Blackberry devices, this is the BBN used for messaging between Blackberry's.
The Phone No. and Type columns display the phone number and device type, and the Battery column displays the remaining battery percentage when the last signal was sent.
The Alerts column displays a count of unclosed alerts for the device, and shows a red circle if the count is above 0. If any of these alerts are actually an SOS, then a red dot is shown in the SOS column.
The Country column displays the name of the country that the last signal was positioned within. The actual country that the device is within could be stated incorrectly near to national borders, if the device is not positioned by GPS. The country in this column is calculated from the latitude and longitude of the last position signal, relative to the vectors of the country borders stored in the GeoReach tracking database. An alternative source of country is derived from the mobile network that the device is connected to. Again, this may not be the actual country that the device is in if the device is near national borders. For example, mobile phone devices have been known to be connected to a French mobile network when they are actually near the south coast of England.

Trails: Ability to review locations of a selected Asset over last number of selected days.

GPS Trail Days: The operator can select or enter the number of days prior to the last position signal to display. The default is to display just one day of trails, but the operator can display up to 30 days of position trails.

Trails Listing: A unique number is assigned to each row in the Trails listing, and this number is also displayed in the centre of the associated green icon at the signal position on the map. The operator can optionally choose to display green lines linking each trail position chronologically. The green icons and optional lines between them are displayed progressively fainter as they go back in time. One of the columns in the listing displays the Signal Time that includes a day/night time circle. The corresponding green asset icon on the map is shaded either yellow or black to represent day or night time too. The Data Type columns display the type of position signal, and the Country column displays the name of the country that the signal was positioned within.

News: Ability to view location specific news from selected news sources. Rich Site Summary (RSS) news feeds from a number of specified sources (BBC, Reuters, CNN) are currently parsed by a free geo-tagging service. This service looks for known place names within the title and body of the article and adds the latitude/longitude co-ordinates to turn the feeds into GeoRSS feeds. There can be multiple places mentioned within a news article; therefore the news article can be displayed in several locations simultaneously on the map. Furthermore, there may be many news articles that mention the same place, therefore there may be multiple icons at the same place on the map. In an example, the choice of GeoRSS news feed sources and the category of news is associated with the organisation in the GeoReach tracking database.

News listing: A unique identifier is assigned to each row in the News listing, and this identifier is also displayed in the centre of the associated yellow/orange icon at the news position on the map. The operator can choose whether to display the icons on the map or not, and can filter the items in the news listing to those within an overlaid rectangle on the map. The size of this rectangle can be controlled by slider that changes the number of degrees latitude and longitude. The listing displays the source, date, title and body, along with hyperlinks to the news article on the web and their location in Bing or Google Maps.

Search: Ability to search for types of buildings in optionally specified location. This feature uses Microsoft Bing Maps Search Service to search for a type of building or business. The operator enters the type of building required to search for. If the operator does not enter an optional location in the query, then the current location at the centre of the map is used. The operator can choose whether to display the query result items on the map or not.

Results listing: A unique number is assigned to each row in the Search listing, and this number is also displayed in the centre of the associated pink icon at the result item's position on the map. The centre of the search is displayed, along with the distance (in km) from the centre of the search to the result item. A corresponding pink line connects the centre of the search to each result item on the map. The listing also displays the name, address, and phone number of the result item, along with hyperlinks to any associated web page, in addition to Bing and Google maps.

Places: Ability to find and navigate to specified locations or lat/lon co-ordinates. Also has ability to find nearest known location to viewed position. This feature uses Microsoft Bing Maps Geocode Service to either obtain a latitude/longitude co-ordinate for an entered point of interest, address or place name; or to find the place at the centre of the displayed map (Reverse Geocode). The operator can choose whether to display the results on the map or not. The operator may zoom into the map in order to get an address for the centre of the map. The granularity of address depends upon the data available from the Bing Maps service. For example, individual buildings may be identified in North America, but only roads or even towns in remoter parts of Africa.

Places listing: A unique number is assigned to each row in the Places listing, and this number is also displayed in the centre of the associated brown icon at the signal position on the map. The listing also displays the name, entity type, result confidence and match code of the result item, along with hyperlinks to Bing and Google maps.

Geo-Fences: Ability to display and navigate to geo-fences and to open relevant web pages about them. GeoReach tracking database can store geo-fences (sometimes referred to as placemarks), which can be associated with organisations, groups or individuals. These geo-fences can have an assigned risk level, name, description, country and a web page for more information. The operator can select any geo-fence collection that they have permission to view, and choose whether to display them on the map or not. The geo-fences are stored as a named collection of geo-fences in the GeoReach tracking database. Each geo-fence has an associated kml (Keyhole Markup Language) file, along with extra details, such as name, description and country. Each geo-fence can contain multiple items, which can each be a point, multi-segmented line or a boundary. Geo-fences can be edited or imported in the WorldViewer interface; editing ability may be provided in the client portal.

Geo-fences listing: A unique number is assigned to each row in the Geo-Fences listing, and this number is also displayed in the centre of the associated aqua-green icon at the centre of the geo-fence position on the map. The listing also displays the name, description, country code, and the risk level (as a coloured circle) of each item, along with hyperlinks to any web-page for more information, and to Bing and Google maps.

Countries: Ability to navigate to countries and to open relevant web pages about them. The GeoReach tracking database stores some information about each country in the world, and this information is presented to the operator, who can filter the listing by the start letter of the country name.

Countries listing: The listing displays each country that starts with the selected letter, along with its capital and all of the international identifiers for it. It also provides filtered hyperlinks to Wikipedia and the CIA Factbook, along with Bing and Google Maps. The Microsoft Bing Maps Geocode Service is used to find the location of the country in the world, and, when the user selects a country in the listing, the result item is added to the list of places found, and so is assigned a unique number in the Places listing, and is displayed with brown icon on the map.

Users: Ability to view users detailed information, including paired devices. A user is stored as a unique entry in the GeoReach tracking database, and can be paired with zero, one or more mobile devices. In an example, only administrators can edit user details using either WorldViewer or the Admin Web; in another example permission controlled editing capabilities are provided in the client portal.

Users listing: This list displays title, first name, last name and greeting of each user, along with the contact and primary device phone number. Any associated email address is provided as a hyperlink to provide a pro-forma email using the operators registered email system. As a user can have no or multiple devices, the count of devices that they are paired with, along with a scrollable list of each paired device.

### Client Reporter Overview

This may be provided as an Excel add-in to provide login-controlled asset reports. This Excel add-in uses the same web-service as the client portal, and creates a new Excel workbook for each subscriber (user device) selected. The position trails for the selected user are imported into an Excel table, and three different Pivot Tables and Charts are created from this data. These reports provide the client's manager to review the usage and efficacy of the GeoReach tracker application on each mobile device that they have oversight for.

Positions per Day: Bar-chart showing daily usage pattern. This chart shows the break-down of the positions received by type for each day over the selected period. The most accurate positions, where type equals Standard, are obtained via GPS satellites. The GeoReach tracking database stores the associated cell tower identifier with these Standard position signals. If a position signal is received without a GPS co-ordinate, but with a previously known cell tower identifier, then the mobile device position is stored as the centre of the GPS signals from that cell tower, with accuracy equal to a circle circumscribed around all of those points. If a position signal is received without a GPS co-ordinate, or without a known cell tower identifier, then the cell tower is looked up in several commercial, for example Location-API, and/or public databases, for example OpenCellID or OpenBMap, of cell tower positions. The source of this derived position and its accuracy is then stored against the position signal.

Positions per Hour: Clock-face chart showing hourly usage pattern. This chart shows the break-down of the positions received by type for each hour of the day over the selected period. This chart would typically reveal the hourly usage pattern of the mobile device. For example, an office worker would be at home over night, travel to work, in an office during the day, then travelling home at night. This would generally show a signal type of Standard whilst travelling because the mobile device can reach the GPS satellites; and Previous Position when at home because we have previously captured the cell tower identifier via GPS positions; with either Previous Position or from one of the fall-back cell tower position databases that are accessed via a web-service.

Battery Usage: Area chart showing daily battery levels. This chart show the battery level received for each day over the selected period. This chart should demonstrate that the battery of the mobile device does not discharge completely before its normal nightly chargings.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Concepts

There are multiple concepts, described below as concepts ‘A-H’, in this disclosure. The following may be helpful in defining these concepts. Aspects of the concepts may be combined.

### A. Monitoring System for Monitoring a Plurality of Mobile Devices

There is provided a monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, the server storing a time series of location data for each device, wherein the server is configured to generate an alert message identifying the first mobile device in response to a time series of location data from the first mobile device satisfying a condition.

The above may include additionally any of the following, alone or in combination:
the server is configured to generate a plurality of alert messages, each alert message identifying the first mobile device in response to a time series of location data from the first mobile device satisfying a condition corresponding to a respective alert message.
location data corresponds to a location of the corresponding mobile device.
the first mobile device includes an integral GPS receiver, and location data corresponds to a GPS location of the first mobile device.
the first mobile device activates and deactivates the integral GPS receiver a multiplicity of times according to a predefined time schedule.
the plurality of mobile devices include a plurality of smartphone platforms.
the plurality of mobile devices each includes a touchscreen, each touchscreen displaying an icon or button which is operable to generate an SOS alert at the server in response to a single user touch of the icon or button.
each device includes a microphone and audio is recorded automatically by a device and sent to the server in response to a selection of an SOS alert at the device.
each device includes a camera and photographs are recorded automatically by a device and sent to the server in response to a selection of an SOS alert at the device.
each device includes a camera and video is recorded automatically by a device and sent to the server in response to a selection of an SOS alert at the device.
news is pushed by the server to mobile devices in real time, tailored to their precise location.
each mobile device of the plurality of mobile devices is operable to disable a sending of a GPS location while otherwise operating normally.
the monitoring system further comprises a computer system including a display, wherein the computer system is arranged to display the alert message on the display of the computer system.
the computer system is arranged to display images from a plurality of mobile devices on which an SOS alert has been selected.
the computer system is arranged to display CCTV images from a location of a mobile device which has generated an SOS alert.
the computer system is operable to receive input of a Geofence region.
the computer system is operable to receive input of a Geofence region drawn freehand on a representation of a digital map.
the computer system is operable to receive input of a Geofence region, and to display which mobile devices of the plurality of mobile devices are present in the GeoFence region in response to the received input of the Geofence region.
the computer system is connected to the server via a telecommunications network.
the computer system is connected to the server via a local network.
the computer system is portable.
the computer system display displays splitscreen, multi-angle, real-time video.
the computer system includes a simulation system.
the condition is the first mobile device entering a Geofence region.
the condition is the first mobile device entering a Geofence region during a predefined time interval.
the condition is the first mobile device leaving a Geofence region.
the condition is the first mobile device leaving a Geofence region during a predefined time interval.
the condition is the first mobile device failing to leave a Geofence region by a predefined time.
a Geofence region is discontinuous in that it comprises a plurality of Geofences.
a GeoFence is defined by a route including a start and a destination, and a predefined width of the route.
the condition is the first mobile device is measured as exceeding a predefined speed.
the plurality of mobile devices includes two devices registered at the server as being paired, and wherein the condition is the separation of the two paired devices by greater than a predefined distance.
the server is arranged to send the alert message to parties on a list accessible to the server.
the monitoring system includes a message gateway connected to the server, the message gateway arranged to queue messages sent by the plurality of mobile devices to the server.
the plurality of mobile devices includes covert devices.

There is further provided a server of the monitoring system according to any of the above statements.

There is further provided a mobile device of the monitoring system according to any of the above statements, wherein the mobile device includes a touchscreen, the mobile device programmed such that the touchscreen displays an icon or button which is operable to generate an SOS alert at the server in response to a single user touch of the icon or button.

There is further provided a method of generating an alert message in a monitoring system for monitoring a plurality of mobile devices registered at a server, the system comprising the server and the plurality of mobile devices registered at the server, the plurality of mobile devices including a first mobile device, comprising the steps of:

(i) each mobile device acquiring location data;
(ii) each mobile device sending the acquired location data to the server via a telecommunications network;
(iii) the server storing a time series of location data for each device, and
(iv) the server generating the alert message which identifies the first mobile device in response to a time series of location data from the first mobile device satisfying a condition.

There is further provided a computer program product embodied on a non-transient medium, the computer program product operable to generate an alert message in a monitoring system for monitoring a plurality of mobile devices registered at a server the system comprising the server and the plurality of mobile devices registered at the server, the plurality of mobile devices including a first mobile device, the computer program product operable to:

(i) receive at the server location data acquired at each mobile device,
(ii) store at the server a time series of location data for each device,
(iii) generate an alert message identifying the first mobile device in response to a time series of location data from the first mobile device satisfying a condition.

There is further provided a computer program product embodied on a non-transient medium, the computer program product operable to generate an SOS message in a monitoring system for monitoring a plurality of mobile devices registered at a server the system comprising the server and the plurality of mobile devices registered at the server, the plurality of mobile devices including a first mobile device including a touchscreen, the computer program product operable to:

(i) acquire location data for the first mobile device
(ii) transmit acquired location data for the first mobile device to the server via a telecommunications network,
(iii) display on the touchscreen an icon or button which is operable to generate an SOS alert at the server in response to a single user touch of the icon or button, and
(iv) transmit an SOS alert to the server in response to a single user touch of the icon or button.

### B. Monitoring System for Monitoring a Pair of Paired Mobile Devices

There is provided a monitoring system for monitoring a pair of paired mobile devices registered as a pair at a server, the system comprising the server and the pair of mobile devices registered at the server, wherein each mobile device is arranged to acquire location data and to send the acquired location data to the server via a telecommunications network, the server storing a time series of location data for each device, wherein the server is configured to generate an alert message identifying the pair of mobile devices in response to a time series of location data from the pair of mobile devices satisfying the condition of the separation of the two paired devices by greater than a predefined distance.

C. Monitoring System in which a GeoFence can be Created which Immediately Identifies Who is in a GeoFence Area.

A monitoring system for monitoring a plurality of mobile devices registered at a server, the system comprising the server and the plurality of mobile devices registered at the server, wherein each mobile device is arranged to acquire location data and to send the acquired location data to the server via a telecommunications network, the server storing a time series of location data for each device, wherein the monitoring system further includes the computer system including a display, wherein the computer system is operable to receive input of a Geofence region, and to display immediately which mobile devices of the plurality of mobile devices are present in the GeoFence region in response to the received input of the Geofence region.

D. Monitoring System with Battery Saving

A monitoring system for monitoring a plurality of mobile devices registered at a server, the system comprising the server and the plurality of mobile devices registered at the server, wherein each mobile device is arranged to acquire location data and to send the acquired location data to the server via a telecommunications network, the server storing a time series of location data for each device, wherein the each mobile device includes an integral GPS receiver and a battery, and location data corresponds to a GPS location of the first mobile device, and wherein each mobile device activates and deactivates the integral GPS receiver a multiplicity of times according to a predefined time schedule, and wherein the integral GPS receiver is activated only just before a GPS location is due to be sent to the server.

The above may include additionally any of the following, alone or in combination:
the mobile devices transmit their battery levels to the server and the server records a time series of battery level for each device.
The server is operable to provide a battery level history report for any device of the plurality of devices.

### E. Monitoring System Including a Message Gateway Arranged to Queue Messages

A monitoring system for monitoring a plurality of mobile devices registered at a server, the system comprising the server and the plurality of mobile devices registered at the server, wherein each mobile device is arranged to acquire location data and to send the acquired location data to the server via a telecommunications network, the server storing a time series of location data for each device, wherein the monitoring system includes a message gateway connected to the server, the message gateway arranged to queue messages sent by the plurality of mobile devices to the server.

### F. Monitoring System Including a Simulation System

A monitoring system for monitoring a plurality of mobile devices registered at a server, the system comprising the server and the plurality of mobile devices registered at the server, wherein each mobile device is arranged to acquire location data and to send the acquired location data to the server via a telecommunications network, the server storing a time series of location data for each device, wherein the monitoring system further comprises a computer system including a display, wherein the computer system includes a simulation system.

The above may include additionally any of the following, alone or in combination:
the simulation system includes a route simulator.
the simulation system is operable to import routes.

### G. Monitoring System Including a World Viewer User Interface

A monitoring system for monitoring a plurality of mobile devices registered at a server, the system comprising the server, wherein each mobile device is arranged to acquire location data and to send the acquired location data to the server via a telecommunications network, the server storing a time series of location data for each device, wherein the monitoring system further comprises a computer system including a display and an input system (such as a keyboard, a mouse, or a touchscreen), wherein the computer system is configured to provide a user interface on the display which is arranged to display where all the tracked people or devices are.

The above may include additionally any of the following, alone or in combination:
the system including the plurality of mobile devices registered at the server.
where all the tracked people or devices are displayed in one window on the display.
Any aspect described in this document regarding a World Viewer or WorldViewer.

### H. Monitoring System for Monitoring a Plurality of Mobile Devices

There is provided a monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, wherein the server is configured to generate an alert message identifying the first mobile device in response to location data from the first mobile device satisfying a condition.

The above may include additionally any of the following, alone or in combination:
Any aspect of concept A.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, the server storing a time series of location data for each device, wherein the server is configured to generate an alert message identifying the first mobile device in response to a time series of location data from the first mobile device satisfying a condition.

2. Monitoring system of claim 1, wherein the server is configured to generate a plurality of alert messages, each alert message identifying the first mobile device in response to a time series of location data from the first mobile device satisfying a condition corresponding to a respective alert message.

3. Monitoring system of claim 1, wherein location data corresponds to a location of the corresponding mobile device.

4. Monitoring system of claim 1, wherein the first mobile device includes an integral GPS receiver, and location data corresponds to a GPS location of the first mobile device.

5. Monitoring system of claim 4, wherein the first mobile device activates and deactivates the integral GPS receiver a multiplicity of times according to a predefined time schedule.

6. Monitoring system of claim 1, wherein the plurality of mobile devices include a plurality of smartphone platforms.

7. Monitoring system of claim 1, wherein the plurality of mobile devices each includes a touchscreen, each touchscreen displaying an icon or button which is operable to generate an SOS alert at the server in response to a single user touch of the icon or button.

8. Monitoring system of claim 1, wherein each device includes a microphone and audio is recorded automatically by a device and sent to the server in response to a selection of an SOS alert at the device.

9. Monitoring system of claim 1, wherein each device includes a camera and photographs are recorded automatically by a device and sent to the server in response to a selection of an SOS alert at the device.

10. Monitoring system of claim 1, wherein each device includes a camera and video is recorded automatically by a device and sent to the server in response to a selection of an SOS alert at the device.

11. Monitoring system of claim 1, wherein news is pushed by the server to mobile devices in real time, tailored to their precise location.

12. Monitoring system of claim 1, wherein each mobile device of the plurality of mobile devices is operable to disable a sending of a GPS location while otherwise operating normally.

13. Monitoring system of claim 1, wherein the monitoring system further comprises a computer system including a display, wherein the computer system is arranged to display the alert message on the display of the computer system.

14. Monitoring system of claim 13, wherein the computer system is arranged to display images from a plurality of mobile devices on which an SOS alert has been selected.

15. Monitoring system of claim 13, wherein the computer system is arranged to display CCTV images from a location of a mobile device which has generated an SOS alert.

16. Monitoring system of claim 13, wherein the computer system is operable to receive input of a Geofence region.

17. Monitoring system of claim 16, wherein the computer system is operable to receive input of a Geofence region drawn freehand on a representation of a digital map.

18. Monitoring system of claim 16, wherein the computer system is operable to receive input of a Geofence region, and to display which mobile devices of the plurality of mobile devices are present in the GeoFence region in response to the received input of the Geofence region.

19. Monitoring system of claim 13, wherein the computer system is connected to the server via a telecommunications network.

20. Monitoring system of claim 13, wherein the computer system is connected to the server via a local network.

21. Monitoring system of claim 13, wherein the computer system is portable.

22. Monitoring system of claim 13, wherein the computer system display displays splitscreen, multi-angle, real-time video.

23. Monitoring system of claim 13, wherein the computer system includes a simulation system.

24. Monitoring system of claim 1, wherein the condition is the first mobile device entering a Geofence region.

25. Monitoring system of claim 24, wherein the condition is the first mobile device entering a Geofence region during a predefined time interval.

26. Monitoring system of claim 1, wherein the condition is the first mobile device leaving a Geofence region.

27. Monitoring system of claim 26, wherein the condition is the first mobile device leaving a Geofence region during a predefined time interval.

28. Monitoring system of claim 1, wherein the condition is the first mobile device failing to leave a Geofence region by a predefined time.

29. Monitoring system of claim 16, wherein a Geofence region is discontinuous in that it comprises a plurality of Geofences.

30. Monitoring system of claim 16, wherein a GeoFence is defined by a route including a start and a destination, and a predefined width of the route.

31. Monitoring system of claim 1, wherein the condition is the first mobile device is measured as exceeding a predefined speed.

32. Monitoring system of claim 1, wherein the plurality of mobile devices includes two devices registered at the server as being paired, and wherein the condition is the separation of the two paired devices by greater than a predefined distance.

33. Monitoring system of claim 1, wherein the server is arranged to send the alert message to parties on a list accessible to the server.

34. Monitoring system of claim 1, wherein the monitoring system includes a message gateway connected to the server, the message gateway arranged to queue messages sent by the plurality of mobile devices to the server.

35. Monitoring system of claim 1, wherein the plurality of mobile devices includes covert devices.

36. The server of the monitoring system of claim 1.

37. A mobile device of claim 1, wherein the mobile device includes a touchscreen, the mobile device programmed such that the touchscreen displays an icon or button which is operable to generate an SOS alert at the server in response to a single user touch of the icon or button.

38. Method of generating an alert message in a monitoring system for monitoring a plurality of mobile devices registered at a server the system comprising the server and the plurality of mobile devices registered at the server, the plurality of mobile devices including a first mobile device, comprising the steps of:
(i) each mobile device acquiring location data;
(ii) each mobile device sending the acquired location data to the server via a telecommunications network;
(iii) the server storing a time series of location data for each device, and
(iv) the server generating the alert message which identifies the first mobile device in response to a time series of location data from the first mobile device satisfying a condition.

39. Computer program product embodied on a non-transient medium, the computer program product operable to generate an alert message in a monitoring system for monitoring a plurality of mobile devices registered at a server, the system comprising the server and the plurality of mobile devices registered at the server, the plurality of mobile devices including a first mobile device, the computer program product operable to:
(i) receive at the server location data acquired at each mobile device,
(ii) store at the server a time series of location data for each device,
(iii) generate an alert message identifying the first mobile device in response to a time series of location data from the first mobile device satisfying a condition.

40. Computer program product embodied on a non-transient medium, the computer program product operable to generate an SOS message in a monitoring system for monitoring a plurality of mobile devices registered at a server, the system comprising the server and the plurality of mobile devices registered at the server, the plurality of mobile devices including a first mobile device including a touchscreen, the computer program product operable to:
(i) acquire location data for the first mobile device
(ii) transmit acquired location data for the first mobile device to the server via a telecommunications network,
(iii) display on the touchscreen an icon or button which is operable to generate an SOS alert at the server in response to a single user touch of the icon or button, and
(iv) transmit an SOS alert to the server in response to a single user touch of the icon or button.
